(19) United States
(12) Patent Application Publication
(10) Pub. No.: US 2026/0032647 A1
(43) Pub. Date: Jan. 29, 2026

(54) TECHNIQUES FOR RE-PURPOSING USER EQUIPMENT (UE) CAPABILITIES IN TIME, FREQUENCY, AND SPATIAL DOMAINS

(71) Applicant: QUALCOMM Incorporated, San Diego, CA (US)

(72) Inventors: Kianoush HOSSEINI, San Diego, CA (US); Raveesh JUNEJA, Hyderabad (IN); Gokul SRIDHARAN, Sunnyvale, CA (US); Timo Ville VINTOLA, San Diego, CA (US); Saranyan NAGARAJAN, Hyderabad (IN)

(21) Appl. No.: 18/780,997

(22) Filed: Jul. 23, 2024

(51) Int. Cl. H04W 72/044; H04W 72/51

(52) U.S. Cl. CPC H04W 72/044; H04W 72/51

(57) ABSTRACT

Methods, systems, and devices for wireless communications are described. In some cases, a user equipment (UE) may transmit a first control message indicative of a capability of the UE to support re-use of UE resources across different dimensions, where the first control message is configured to report capabilities of the UE to support re-use of UE resources in a time domain, a frequency domain, a spatial domain, or any combination thereof. Additionally, the UE may receive a second control message indicative of a change in configuration of the UE or a change in scheduling of the UE and may adapt one or more resources in the time domain, the frequency domain, the spatial domain, or any combination thereof, in accordance with the change in configuration or the change in scheduling based on the capability of the UE to support re-use of UE resources across different dimensions.

### FIELD OF TECHNOLOGY

The following relates to wireless communications, including techniques for re-purposing user equipment (UE) capabilities in time, frequency, and spatial domains.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a UE is described. The method may include transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof, receiving a second control message indicative of a change in configuration of the UE or a change in scheduling of the UE, and adapting one or more resources in the time domain, the frequency domain, the spatial domain, or any combination thereof, in accordance with the change in configuration or the change in scheduling based on the capability of the UE to support re-use of UE resources across different dimensions.

A UE for wireless communications is described. The UE may include one or more memories storing processor executable code, and one or more processors coupled with the one or more memories. The one or more processors may individually or collectively be operable to execute the code to cause the UE to transmit a first control message indicative of a capability of the UE to support re-use of UE resources across different dimensions, where the first control message is configured to report capabilities of the UE to support re-use of UE resources in a time domain, a frequency domain, a spatial domain, or any combination thereof, receive a second control message indicative of a change in configuration of the UE or a change in scheduling of the UE, and adapt one or more resources in the time domain, the frequency domain, the spatial domain, or any combination thereof, in accordance with the change in configuration or the change in scheduling based on the capability of the UE to support re-use of UE resources across different dimensions.

Another UE for wireless communications is described. The UE may include means for transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof, means for receiving a second control message indicative of a change in configuration of the UE or a change in scheduling of the UE, and means for adapting one or more resources in the time domain, the frequency domain, the spatial domain, or any combination thereof, in accordance with the change in configuration or the change in scheduling based on the capability of the UE to support re-use of UE resources across different dimensions.

A non-transitory computer-readable medium storing code for wireless communications is described. The code may include instructions executable by one or more processors to transmit a first control message indicative of a capability of the UE to support re-use of UE resources across different dimensions, where the first control message is configured to report capabilities of the UE to support re-use of UE resources in a time domain, a frequency domain, a spatial domain, or any combination thereof, receive a second control message indicative of a change in configuration of the UE or a change in scheduling of the UE, and adapt one or more resources in the time domain, the frequency domain, the spatial domain, or any combination thereof, in accordance with the change in configuration or the change in scheduling based on the capability of the UE to support re-use of UE resources across different dimensions.

Some examples of the method, UEs, and non-transitory computer-readable medium described herein may further include operations, features, means, or instructions for receiving one or more third control messages indicative of one or more time intervals, one or more duty cycles, or both, associated with the change in configuration or the change in scheduling, where adaptation of the one or more resources may be based on the one or more time intervals, the one or more time duty cycles, or both.

Some examples of the method, UEs, and non-transitory computer-readable medium described herein may further include operations, features, means, or instructions for transmitting a request message that requests the one or more time intervals, the one or more time duty cycles, or both, associated with the change in configuration or the change in scheduling, where receiving the one or more third control messages may be based on transmitting the request message.

In some examples of the method, UEs, and non-transitory computer-readable medium described herein, the one or more time intervals, the one or more time duty cycles, or both, may be indicated per domain associated with the change in configuration of the UE or the change in scheduling of the UE.

In some examples of the method, UEs, and non-transitory computer-readable medium described herein, the one or more third control messages include a single third control message and the single third control message jointly indicates the one or more time intervals, the one or more time duty cycles, or both, per domain.

In some examples of the method, UEs, and non-transitory computer-readable medium described herein, the one or more third control messages include a set of multiple third control messages and the set of multiple third control messages separately indicate the one or more time intervals, the one or more time duty cycles, or both, per domain.

In some examples of the method, UEs, and non-transitory computer-readable medium described herein, the one or more third control messages include a single third control message and the single third control message may be a same control message as the second control message.

In some examples of the method, UEs, and non-transitory computer-readable medium described herein, the capability of the UE to support re-use of UE resources in across different dimensions may be reported per domain, per band combination, per band per band combination, per feature set per CC, or any combination thereof.

In some examples of the method, UEs, and non-transitory computer-readable medium described herein, the change in configuration or the change in scheduling may be associated with a first CC of a set of multiple CCs supported by the UE and the adaptation of the one or more resources may be associated with one or more second CC of the set of multiple CCs based on the change in configuration or the change in scheduling being associated with the first CC of the set of multiple CCs.

In some examples of the method, UEs, and non-transitory computer-readable medium described herein, the change in configuration or the change in scheduling may be associated with a first domain of a set of multiple domains including the time domain, the frequency domain, and the spatial domain and the adaptation of the one or more resources may be associated with one or more second domains of the set of multiple domains based on the change in configuration or the change in scheduling being associated with the first domain of the set of multiple domains.

In some examples of the method, UEs, and non-transitory computer-readable medium described herein, the first domain and at least a one of the one or more second domains may be a same domain.

In some examples of the method, UEs, and non-transitory computer-readable medium described herein, the first domain and the one or more second domains may be different domains.

Some examples of the method, UEs, and non-transitory computer-readable medium described herein may further include operations, features, means, or instructions for receiving a request message that requests the UE to report the adaptation of the one or more resources, where receiving the request message may be based on receiving the second control message and transmitting a response message indicative of the adaptation of the one or more resources, where adapting the one or more resources may be based on transmitting the response message.

In some examples of the method, UEs, and non-transitory computer-readable medium described herein, the request message requests the UE to report the adaptation of the one or more resources in at least one of the time domain, the frequency domain, and the spatial domain.

In some examples of the method, UEs, and non-transitory computer-readable medium described herein, the request message may be indicative of a candidate adaptation of the one or more resources and the response message may be indicative of whether the UE may be able to support the candidate adaptation.

Some examples of the method, UEs, and non-transitory computer-readable medium described herein may further include operations, features, means, or instructions for transmitting a third control message indicative of a set of multiple a candidate adaptations of the one or more resources in the time domain, the frequency domain, the spatial domain, or any combination thereof, and usage costs that may be individually associated with each candidate adaptation of the set of multiple candidate adaptations, where the change in configuration of the UE or the change in scheduling of the UE may be based on the usage costs.

In some examples of the method, UEs, and non-transitory computer-readable medium described herein, the usage costs may be per CC.

In some examples of the method, UEs, and non-transitory computer-readable medium described herein, the third control message may be indicative of a threshold processing power supported by the UE and the change in configuration or the change in scheduling may be based on the threshold processing power supported by the UE.

Some examples of the method, UEs, and non-transitory computer-readable medium described herein may further include operations, features, means, or instructions for receiving a third control message indicative of a first mode of the UE of a set of multiple modes supported by the UE, where the set of multiple modes includes the first mode that indicates that the UE may be to adapt the one or more resources based on the change in configuration or the change in scheduling and a second mode that indicates that the UE may be to refrain from adaptation of the one or more resources.

Some examples of the method, UEs, and non-transitory computer-readable medium described herein may further include operations, features, means, or instructions for receiving a third control message that indicates that the UE may be to adapt the one or more resources based on the change in configuration or the change in scheduling.

Some examples of the method, UEs, and non-transitory computer-readable medium described herein may further include operations, features, means, or instructions for receiving a third control message indicative of the adaptation of the one or more resources in the time domain, the frequency domain, the spatial domain, or any combination thereof, where adaptation of the one or more resources may be based on receiving the third control message.

Some examples of the method, UEs, and non-transitory computer-readable medium described herein may further include operations, features, means, or instructions for transmitting a request message indicative of a candidate adaptation of the one or more resources in the time domain, the frequency domain, the spatial domain, or any combination thereof, where receiving the third control message may be based on transmitting the request message, and where the adaptation of the one or more resources may be based on the candidate adaptation of the one or more resources requested by the UE.

Some examples of the method, UEs, and non-transitory computer-readable medium described herein may further include operations, features, means, or instructions for receiving a third control message indicative of a set of multiple relationships between a set of multiple changes in configuration of the UE, a set of multiple changes in scheduling of the UE, or both, and a set of multiple adaptations of the one or more resources in the time domain, the frequency domain, the spatial domain, or any combination thereof, where adaptation of the one or more resources may be based on the set of multiple relationships.

In some examples of the method, UEs, and non-transitory computer-readable medium described herein, the first control message further indicates one or more threshold durations associated with performing resource adaptation and adaptation of the one or more resources may be based on the one or more threshold durations.

In some examples of the method, UEs, and non-transitory computer-readable medium described herein, the one or more threshold durations may be based on the change in configuration or the change in scheduling.

In some examples of the method, UEs, and non-transitory computer-readable medium described herein, the change in configuration or the change in scheduling may be associated with a SCell activation, a SCell deactivation, a cell dormancy, a change in DRX mode configuration, a BWP switch, a change in scheduling gap, a change in a threshold quantity of MIMO layers, a change in MCS, or any combination thereof.

In some examples of the method, UEs, and non-transitory computer-readable medium described herein, the change in configuration of the UE or the change in scheduling of the UE may be associated with the time domain, the frequency domain, the spatial domain, or any combination thereof.

A method for wireless communications by a network entity is described. The method may include receiving a first control message indicative of a capability of a UE to support re-use of UE resources across different dimensions, where the first control message is configured to report capabilities of the UE to support re-use of UE resources in a time domain, a frequency domain, a spatial domain, or any combination thereof, transmitting a second control message indicative of a change in configuration of the UE or a change in scheduling of the UE, and communicating with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

A network entity for wireless communications is described. The network entity may include one or more memories storing processor executable code, and one or more processors coupled with the one or more memories. The one or more processors may individually or collectively be operable to execute the code to cause the network entity to receive a first control message indicative of a capability of a UE to support re-use of UE resources across different dimensions, where the first control message is configured to report capabilities of the UE to support re-use of UE resources in a time domain, a frequency domain, a spatial domain, or any combination thereof, transmit a second control message indicative of a change in configuration of the UE or a change in scheduling of the UE, and communicate with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

Another network entity for wireless communications is described. The network entity may include means for receiving a first control message indicative of a capability of a UE to support re-use of UE resources across different dimensions, where the first control message is configured to report capabilities of the UE to support re-use of UE resources in a time domain, a frequency domain, a spatial domain, or any combination thereof, means for transmitting a second control message indicative of a change in configuration of the UE or a change in scheduling of the UE, and means for communicating with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

A non-transitory computer-readable medium storing code for wireless communications is described. The code may include instructions executable by one or more processors to receive a first control message indicative of a capability of a UE to support re-use of UE resources across different dimensions, where the first control message is configured to report capabilities of the UE to support re-use of UE resources in a time domain, a frequency domain, a spatial domain, or any combination thereof, transmit a second control message indicative of a change in configuration of the UE or a change in scheduling of the UE, and communicate with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

Some examples of the method, network entities, and non-transitory computer-readable medium described herein may further include operations, features, means, or instructions for transmitting one or more third control messages indicative of one or more time intervals, one or more duty cycles, or both, associated with the change in configuration or the change in scheduling, where adaptation of the one or more resources may be based on the one or more time intervals, the one or more time duty cycles, or both.

Some examples of the method, network entities, and non-transitory computer-readable medium described herein may further include operations, features, means, or instructions for receiving a request message that requests the one or more time intervals, the one or more time duty cycles, or both, associated with the change in configuration or the change in scheduling, where receiving the one or more third control messages may be based on transmitting the request message.

In some examples of the method, network entities, and non-transitory computer-readable medium described herein, the one or more time intervals, the one or more time duty cycles, or both, may be indicated per domain associated with the change in configuration of the UE or the change in scheduling of the UE.

In some examples of the method, network entities, and non-transitory computer-readable medium described herein, the one or more third control messages include a single third control message and the single third control message jointly indicates the one or more time intervals, the one or more time duty cycles, or both, per domain.

In some examples of the method, network entities, and non-transitory computer-readable medium described herein, the one or more third control messages include a set of multiple third control messages and the set of multiple third control messages separately indicate the one or more time intervals, the one or more time duty cycles, or both, per domain.

In some examples of the method, network entities, and non-transitory computer-readable medium described herein, the one or more third control messages include a single third control message and the single third control message may be a same control message as the second control message.

In some examples of the method, network entities, and non-transitory computer-readable medium described herein, the capability of the UE to support re-use of UE resources across different dimensions may be reported per domain, per band combination, per band per band combination, per feature set per CC, or any combination thereof.

In some examples of the method, network entities, and non-transitory computer-readable medium described herein, the change in configuration or the change in scheduling may be associated with a first CC of a set of multiple CCs supported by the UE and the adaptation of the one or more resources may be associated with one or more second CC of the set of multiple CCs based on the change in configuration or the change in scheduling being associated with the first CC of the set of multiple CCs.

In some examples of the method, network entities, and non-transitory computer-readable medium described herein, the change in configuration or the change in scheduling may be associated with a first domain of a set of multiple domains including the time domain, the frequency domain, and the spatial domain and the adaptation of the one or more resources may be associated with one or more second domains of the set of multiple domains based on the change in configuration or the change in scheduling being associated with the first domain of the set of multiple domains.

In some examples of the method, network entities, and non-transitory computer-readable medium described herein, the first domain and at least a one of the one or more second domains may be a same domain.

In some examples of the method, network entities, and non-transitory computer-readable medium described herein, the first domain and the one or more second domains may be different domains.

Some examples of the method, network entities, and non-transitory computer-readable medium described herein may further include operations, features, means, or instructions for transmitting a request message that requests the UE to report the adaptation of the one or more resources, where receiving the request message may be based on receiving the second control message and receiving a response message indicative of the adaptation of the one or more resources, where adapting the one or more resources may be based on transmitting the response message.

In some examples of the method, network entities, and non-transitory computer-readable medium described herein, the request message requests the UE to report the adaptation of the one or more resources in at least one of the time domain, the frequency domain, and the spatial domain.

In some examples of the method, network entities, and non-transitory computer-readable medium described herein, the request message may be indicative of a candidate adaptation of the one or more resources and the response message may be indicative of whether the UE may be able to support the candidate adaptation.

Some examples of the method, network entities, and non-transitory computer-readable medium described herein may further include operations, features, means, or instructions for receiving a third control message indicative of a set of multiple a candidate adaptations of the one or more resources in the time domain, the frequency domain, the spatial domain, or any combination thereof, and usage costs that may be individually associated with each candidate adaptation of the set of multiple candidate adaptations, where the change in configuration of the UE or the change in scheduling of the UE may be based on the usage costs.

In some examples of the method, network entities, and non-transitory computer-readable medium described herein, the usage costs may be per CC.

In some examples of the method, network entities, and non-transitory computer-readable medium described herein, the third control message may be indicative of a threshold processing power supported by the UE and the change in configuration or the change in scheduling may be based on the threshold processing power supported by the UE.

Some examples of the method, network entities, and non-transitory computer-readable medium described herein may further include operations, features, means, or instructions for transmitting a third control message indicative of a first mode of the UE of a set of multiple modes supported by the UE, where the set of multiple modes includes the first mode that indicates that the UE may be to adapt the one or more resources based on the change in configuration or the change in scheduling and a second mode that indicates that the UE may be to refrain from adaptation of the one or more resources.

Some examples of the method, network entities, and non-transitory computer-readable medium described herein may further include operations, features, means, or instructions for transmitting a third control message that indicates that the UE may be to adapt the one or more resources based on the change in configuration or the change in scheduling.

Some examples of the method, network entities, and non-transitory computer-readable medium described herein may further include operations, features, means, or instructions for transmitting a third control message indicative of the adaptation of the one or more resources in the time domain, the frequency domain, the spatial domain, or any combination thereof, where adaptation of the one or more resources may be based on receiving the third control message.

Some examples of the method, network entities, and non-transitory computer-readable medium described herein may further include operations, features, means, or instructions for receiving a request message indicative of a candidate adaptation of the one or more resources in the time domain, the frequency domain, the spatial domain, or any combination thereof, where receiving the third control message may be based on transmitting the request message, and where the adaptation of the one or more resources may be based on the candidate adaptation of the one or more resources requested by the UE.

Some examples of the method, network entities, and non-transitory computer-readable medium described herein may further include operations, features, means, or instructions for transmitting a third control message indicative of a set of multiple relationships between a set of multiple changes in configuration of the UE, a set of multiple changes in scheduling of the UE, or both, and a set of multiple adaptations of the one or more resources in the time domain, the frequency domain, the spatial domain, or any combination thereof, where adaptation of the one or more resources may be based on the set of multiple relationships.

In some examples of the method, network entities, and non-transitory computer-readable medium described herein, the first control message further indicates one or more threshold durations associated with performing resource adaptation and adaptation of the one or more resources may be based on the one or more threshold durations.

In some examples of the method, network entities, and non-transitory computer-readable medium described herein, the one or more threshold durations may be based on the change in configuration or the change in scheduling.

In some examples of the method, network entities, and non-transitory computer-readable medium described herein, the change in configuration or the change in scheduling may be associated with a SCell activation, a SCell deactivation, a cell dormancy, a change in DRX mode configuration, a BWP switch, a change in scheduling gap, a change in a threshold quantity of MIMO layers, a change in MCS, or any combination thereof.

In some examples of the method, network entities, and non-transitory computer-readable medium described herein, the change in configuration of the UE or the change in scheduling of the UE may be associated with the time domain, the frequency domain, the spatial domain, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for re-purposing user equipment (UE) capabilities in time, frequency, and spatial domains in accordance with one or more aspects of the present disclosure.

FIG. 2 shows an example of a wireless communications system that supports techniques for re-purposing UE capabilities in time, frequency, and spatial domains in accordance with one or more aspects of the present disclosure.

FIG. 3 shows an example of a process flow that supports techniques for re-purposing UE capabilities in time, frequency, and spatial domains in accordance with one or more aspects of the present disclosure.

FIGS. 4 and 5 show block diagrams of devices that support techniques for re-purposing UE capabilities in time, frequency, and spatial domains in accordance with one or more aspects of the present disclosure.

FIG. 6 shows a block diagram of a communications manager that supports techniques for re-purposing UE capabilities in time, frequency, and spatial domains in accordance with one or more aspects of the present disclosure.

FIG. 7 shows a diagram of a system including a device that supports techniques for re-purposing UE capabilities in time, frequency, and spatial domains in accordance with one or more aspects of the present disclosure.

FIGS. 8 and 9 show block diagrams of devices that support techniques for re-purposing UE capabilities in time, frequency, and spatial domains in accordance with one or more aspects of the present disclosure.

FIG. 10 shows a block diagram of a communications manager that supports techniques for re-purposing UE capabilities in time, frequency, and spatial domains in accordance with one or more aspects of the present disclosure.

FIG. 11 shows a diagram of a system including a device that supports techniques for re-purposing UE capabilities in time, frequency, and spatial domains in accordance with one or more aspects of the present disclosure.

FIGS. 12 and 13 show flowcharts illustrating methods that support techniques for re-purposing UE capabilities in time, frequency, and spatial domains in accordance with one or more aspects of the present disclosure.

### DETAILED DESCRIPTION

In some wireless communications systems, a user equipment (UE) may receive control signaling configuring one or more resources (e.g., capabilities) of the UE, such that the UE may achieve a threshold (e.g., peak) throughput. However, in some cases, a subset of the one or more resources (e.g., dark resources) may be idle and may not be used by the UE (e.g., cannot be fully utilized by the UE). For example, a UE may operate according to a time domain duplex (TDD) pattern in which the TDD pattern includes any combination of downlink slots, uplink slots, and slots for switching between downlink and uplink, which may be referred to as switching slots. However, the UE may be scheduled to receive downlink, such that the uplink slots, at least a portion of the switching slots, or both, may not be used by the UE. Additionally, or alternatively, the UE may support different capabilities associated with different feature groups (FGs), where each FG is associated with a different level of granularity (e.g., per UE, per band, per band combination (BC), per band per band combination (BoBC), etc). As such, when reporting one or more capabilities for a given FG from the different FGs, the UE may consider all of the FGs, such that the UE may under-report the one or more capabilities of the UE to account for a worst-case configuration, which may or may not occur.

Accordingly, techniques described herein may enable a UE to perform multi-dimensional re-use of one or more resources based on a change in scheduling or a change in configuration. For example, a UE may transmit a first control message indicative of a capability of the UE to support multi-dimensional re-use. In such cases, the first control message may support the UE reporting different multi-dimensional resource re-use capabilities (e.g., one or more capabilities) associated with resource re-use in a time domain, a frequency domain, a spatial domain, or any combination thereof. As such, the UE may receive a second control message indicative of a change in configuration of the UE or a change in scheduling of the UE, and may adapt one or more resources in the time domain, the frequency domain, the spatial domain, or any combination thereof, in accordance with the change in configuration or the change in scheduling based on the capability of the UE to support multi-dimensional re-use.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to techniques for re-purposing UE capabilities in time, frequency, and spatial domains.

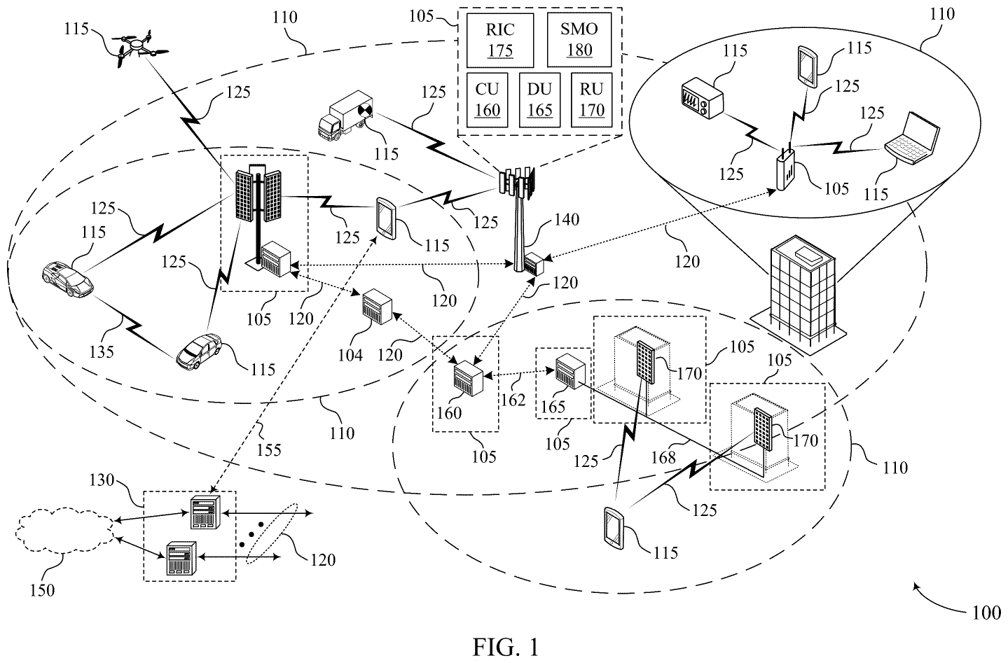

FIG. 1 shows an example of a wireless communications system 100 that supports techniques for re-purposing UE capabilities in time, frequency, and spatial domains in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support techniques to enable a UE 115 to perform multi-dimensional re-use of one or more resources based on a change in scheduling or a change in configuration. For example, a UE 115 may transmit a first control message indicative of a capability of the UE 115 to support multi-dimensional re-use. In such cases, the first control message may support the UE 115 reporting different multi-dimensional resource re-use capabilities (e.g., one or more capabilities) associated with resource re-use in a time domain, a frequency domain, a spatial domain, or any combination thereof. As such, the UE 115 may receive a second control message indicative of a change in configuration of the UE 115 or a change in scheduling of the UE 115, and may adapt one or more resources in the time domain, the frequency domain, the spatial domain, or any combination thereof, in accordance with the change in configuration or the change in scheduling based on the capability of the UE to support multi-dimensional re-use.

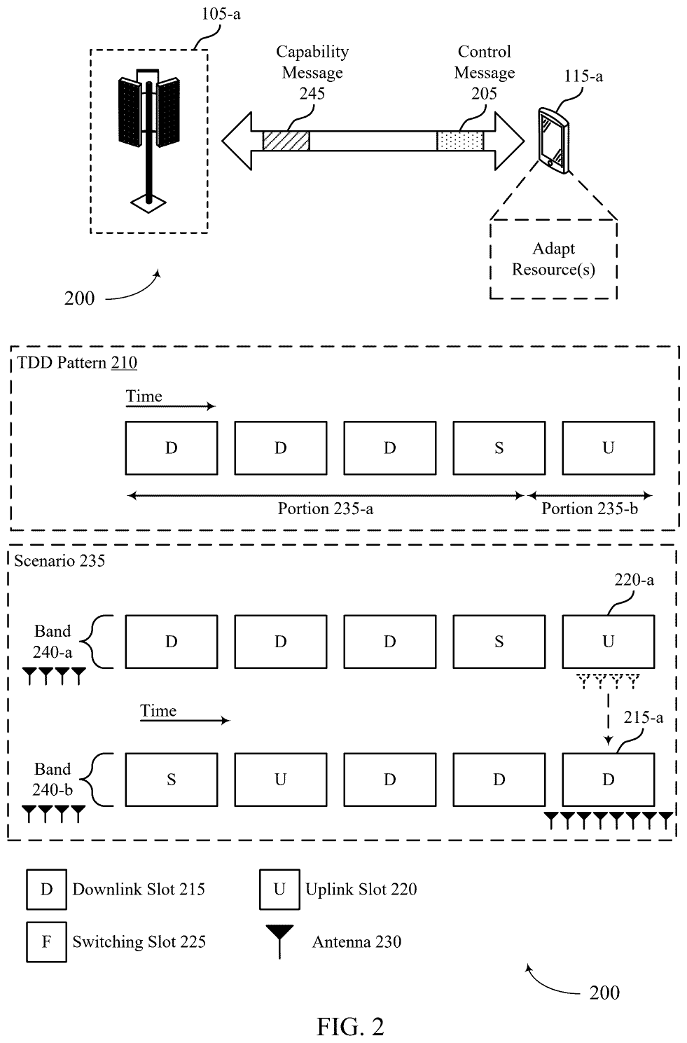

FIG. 2 shows an example of a wireless communications system 200 that supports techniques for re-purposing UE capabilities in time, frequency, and spatial domains in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein

In some wireless communications systems, a UE 115 may receive one or more control messages 205 configuring one or more resources of the UE 115, such that the UE 115 may achieve a threshold (e.g., peak) throughput. However, in some cases, a subset of the one or more resources (e.g., dark resources) may be idle and may not be used by the UE 115 (e.g., cannot be fully utilized by the UE 115). For example, for a single cell, the UE 115 may operate according to a TDD pattern 210, where the TDD pattern 210 includes any combination of downlink slots 215, uplink slots 220, and gaps to perform switching from downlink to uplink (e.g., or visa-versa), which may be referred to as switching slots 225. However, the UE 115 may be scheduled to receive downlink, such that the uplink slots 220, at least a portion of the switching slots 225, or both, may not be used by the UE 115. For example, as depicted in FIG. 2, a UE 115 may support a TDD pattern 210 including 3 downlink slots 215, followed by a switching slot 225, followed by an uplink slot 220. Thus, antennas 230 of the UE 115 (e.g., UE modem radio frequency (RF)/baseband (BB) capabilities) may receive downlink during a portion 235-a (e.g., the downlink slots 215 and at least a first portion of the switching slot 225 may be busy during the portion 235-a) but may remain idle during a portion 235-b (e.g., during a second portion of the switching slot 225 and the uplink slot 220). Similar situations may exist with carrier aggregation (CA). For example, the UE 115-a may support multiple component carriers (CC), where each CC is associated with the TDD pattern 210, such that the antennas 230 of the UE 115 may be idle during a portion 235-b associated with each CC.

Additionally, or alternatively, a UE 115 may support different capability signaling (e.g., capabilities) associated with different FGs, where each FG is associated with a different level of granularity (e.g., per UE, per band 240, per BC, per BoBC, etc.). As such, when reporting one or more capabilities for a given FG from the different FGs, the UE 115 may consider all of the FGs, such that the UE 115 may under-report the one or more capabilities of the UE 115 to account for a worst-case configuration, which may or may not occur. For example, the UE 115 may support a first feature (e.g., FG) associated with a first granularity of “per BoBC” and a second feature (e.g., FG) associated with a second granularity of “per band 240.” In some cases, the UE 115 may support the first feature in a first band combination including a band 240-a and a band 240-b and may support the second feature in each of the band 240-a and the band 240-b. However, the UE 115 may not support the second feature in the band 240-a when the band 240-a is part of the first band combination (e.g., including the band 240-a and the band 240-b). Thus, to avoid a worst-case scenario (e.g., attempting to support the second feature in the band 240-a when the band 240-a is part of the first band combination), the UE 115 may under-report one or more capabilities of the UE 115 (e.g., may be conservative in capability reporting). For example, the UE 115 may report (e.g., under report) that the UE 115 does not support at least one of the first feature and the second feature. However, the worst-case scenario may be unlikely to occur (e.g., may or may not occur).

Thus, in some cases (e.g., according to legacy RF/BB assignment for multi-carrier (MC) operations), when a first set of antennas 230 of a UE 115 associated with a first CC are idle, the UE 115 may attempt to borrow (e.g., share) BB/RF capabilities (e.g., resources) from the first set of antennas 230 for a second set of antennas 230 associated with a second CC to improve performance. For example, the UE 115 may support the first set of antennas 230 associated with the band 240-a (e.g., a first CC) and may support the second set of antennas 230 associated with the band 240-b (e.g., a second CC). In some cases, the UE 115 may support separate antennas 230 across each band 240, such that the first set of antennas 230 is different from the second set of antennas 230. In such cases, the UE 115 may support a larger quantity of multiple input multiple output (MIMO) layers, a higher diversity gain, or both, by sharing BB/RF capabilities across bands 240 (e.g., as compared to not sharing). In some other cases, the UE 115 may support a same set of antennas 230 across the bands 240, such that the first set of antennas 230 is the same as the second set of antennas 230. In such cases, the UE 115 may support a larger BW by sharing BB/RF capabilities across bands 240 (e.g., as compared to not sharing). However, conventional (e.g., legacy) UEs 115 may not support sharing BB/RF capabilities across bands 240. That is, the UEs 115 may experience retuning interruptions (e.g., interruption gaps may not be specified for downlink), may experience inconsistencies in channel estimation and sounding (e.g., channel estimation with different receive antennas 230 at different times, sounding reference signal (SRS) sounding and downlink reception using different antennas), and may not be able to adapt capabilities based on actual scheduling of the UE 115 (e.g., capabilities are fixed, recycled resources cannot be used to scale the MIMO layers or supported BW).

In some other cases, as depicted in a scenario 235, a UE 115 may support separate antennas 230 per band 240, such that the UE 115 may switch antennas 230 (e.g., and/or BB capabilities) to an active band 240. For example, the UE 115 may be scheduled with limited or no uplink during an uplink slot 220-a, such that the first set of antennas 230 associated with the band 240-a may be idle (e.g., idle BB power) during the uplink slot 220-a, but may be scheduled with downlink during a downlink slot 215-a. As such, the UE 115 may share (e.g., switch) the first set of antennas 230 associated with the band 240-a to be associated with the band 240-b (e.g., may switch, or share, the first set of antennas 230 across bands 240), such that the UE 115 may use the first set of antennas 230 and the second set of antennas 230 for reception of downlink during the slot 215-a. Thus, the UE 115 may leverage MIMO and BW scaling to process a larger quantity of layers and to support a higher throughput (e.g., as compared to not performing antenna sharing). In such cases, throughput gain experienced (e.g., achieved) by the UE 115 using antenna sharing may be based on a TDD pattern associated with each band 240 (e.g., each CC), channel conditions, retuning time, switching time (e.g., UE capability, a quantity of switching slots 225), activity on uplink slots 220, activity on downlink slots 215, extra BW available when recycling capabilities, or any combination thereof. For example, different throughput gains achieved by a UE 115 supporting inter-band CA (e.g., TDD+TDD inter-band CA) with shifted TDD patterns, 100 MHz per CC, and 8 antennas 230 (e.g., 4 separate antennas 230 per band 240) may be represented according to Table 1, recreated below. In the context of Table 1, both 1-symbol DMRS and 2-symbol DMRS may not be associated with (e.g., may be without) FDM′ed data (e.g., for 8 layer PDSCH).

TABLE 1
Throughout Scaling with Antenna Sharing

| | Switching | | | |
|---|---|---|---|---|
| | Gaps | | Downlink Throughput Gain | |
| | (quantity of | | 1-symbol | 2-symbol |
| Scheme | symbols) | Uplink | DMRS | DMRS |
| No Antenna | N/A | | 4.60 Gbps | 4.60 Gbps |
| Sharing | | | | |
| Antenna Sharing | 0 | No Uplink | 27% | 26% |
| Antenna Sharing | 1 | No Uplink | 20% | 15% |
| Antenna Sharing | 1 | PUCCH | 13% | 10% |
| Antenna Sharing | 1 | Fully | 6% | 3% |
| | | Loaded | | |
| Antenna Sharing | 4 | No Uplink | 11% | 6% |

| | | | |
|---|---|---|---|
| Antenna Sharing | 4 | PUCCH | Loss compared to “No |
| | | | Antenna Sharing” |

However, antenna sharing (e.g., frequency, grant-based RF-modem reassignment) may also result in interruptions, which may degrade performance of the UE 115. That is, the UE 115, the network entity 105, or both, may not be able to react quickly (e.g., within a threshold duration) to changes in antenna sharing, such that interruptions in communications may occur.

Accordingly, techniques described herein may enable a UE 115, such as the UE 115-a, to re-use one or more resources (e.g., perform RF-modem repurposing) in a time domain, a frequency domain, a spatial domain, or any combination thereof, that may have remained idle (e.g., may be dark resources) without re-use, which may be referred to as multi-dimensional resource re-use. In particular, techniques described herein may enable the UE 115-a to re-use the one or more resources (e.g., capabilities) based on one or more changes in configuration, one or more changes in scheduling, or both (e.g., scenarios, events) that occur less frequently (e.g., as compared to dynamic timelines), that are persistent for a duration of time (e.g., have a guaranteed duty cycle), or both.

That is, the UE 115-a, in a given BC, may be capable of supporting different combinations of configurations (e.g., both BB and RF related), such as different quantities of layers per CC, different BWs per CC, different total BWs, different quantities of physical downlink control channel (PDSCH) or physical uplink shared channel (PUSCH) per slot, different modulation orders, or any combination thereof. Additionally, the UE 115-a may report capabilities of the UE 115-a for each BC. For example, for a first BC including a band 240-a (e.g., B1) and a band 240-b (e.g., B2), the UE 115-a may report, for the band 240-a, a first BW of a first width, a first quantity of CCs equal to 1 CC, and a first threshold (e.g., maximum) quantity of layers equal to 4 layers and may report, for the band 240-b, a second BW of a second width, a second quantity of CCs equal to 2 CCs, and a second threshold (e.g., maximum) quantity of layers equal to 2 layers per CC. However, when scheduled, the UE 115-a may not use all of the reported capabilities (e.g., resources). For example, the UE 115-a may be configured with 1 CC in the band 240-b or with 2 CCs but 1 being deactivated on the band 240-b. As a result, the UE 115-a may be capable of performing additional operations (e.g., doing more) on other dimensions. For example, the UE 115-a may support more PDSCH/PUSCH per slot in a time domain, may support a larger BW or more CCs in a frequency domain, may support more layers in uplink or downlink, or any combination thereof. Thus, to enable the UE 115-a to perform the additional operations, the UE 115-a may report multiple versions of the capabilities of the UE 115-a per BC. However, reporting all possible versions to cover cases that may occur during configuration or scheduling of the UE 115-a may result in increased (e.g., large) overhead. Thus, the UE 115-a may instead report a subset of the possible versions (e.g., or even no repetition of capabilities for a same BC). However, as discussed previously, doing so may result in resources being under-utilized by the UE 115-a.

Thus, when in an RRC connected mode, the UE 115-a may be capable of adapting or modifying at least a subset of capabilities supported by the UE 115-a (e.g., one or more resources configured for the UE 115-a) in a time domain, a frequency domain, a spatial domain, or any combination thereof, based on a change in configuration of the UE 115-a, a change in scheduling of the UE 115-a, or both.

For example, in the frequency domain, configurations of the UE 115-a may align (e.g., associated with) with capabilities reported for a set of configured carriers (e.g., CCs), however, based on secondary cell (SCell) deactivation or dormancy, the UE 115-a may be capable of reassigning one or more resources to other dimensions (e.g., the time domain, the frequency domain, or both). For example, when a BWP of the UE 115-a is changed (e.g., based on the change in configuration of the UE 115-a, the change in scheduling of the UE 115-a, or both) and a new activated BWP has a smaller BWP than the old BWP, the UE 115-a may be capable of reusing one or more capabilities of the UE 115-a (e.g., one or more resources) in other dimensions on a same CC or different CCs (e.g., than a CC associated with the BWP).

Additionally, or alternatively, in the time domain, the UE 115-a may adjust a granularity of PDSCH/PUSCH scheduling. For example, two discontinuous reception (DRX) groups may be configured for the UE 115-a, and on duration and off durations of the two DRX groups may not align. Thus, when one set of CCs, under a first DRX group of the two DRX groups, are outside of a respective on duration, the UE 115-a may reuse one or more capabilities of the UE 115-a (e.g., one or more resources, RF-modem capabilities) to improve performance of the UE 115-a in other dimensions of a second set of CCs (e.g., associated with a second DRX group of the two DRX groups). That is, the UE 115-a may re-use one or more resources associated with the first set of CCs for the second set of CCs during an off duration associated with the first set of CCs. In some examples, a network entity, such as the network entity 105-a may indicate (e.g., guarantee) a gap across PDSCH/PUSCH to the UE 115-a to slow down a BB clock of the UE 115-a on a given CC (e.g., carrier). Thus, the UE 115-a may re-use one or more capabilities in other dimensions (e.g., if not done for the purpose of power savings). For example, the UE 115-a may support a larger BW on another CC or may add an SCell. Additionally, or alternatively, some CCs may be configured with semi-persistent scheduling (SPS), CG-PUSCH, or both, with a given periodicity and time gap when the network entity 105-a schedules a retransmission. Additionally, or alternatively, the network entity 105-a may support (e.g., guarantee) that transmissions and receptions are feedback-less (e.g., HARQ-less) may relax one or more timelines (e.g., N1/N2), or both.

Additionally, or alternatively, in the spatial domain, the network entity 105-a may configure the UE 115-a with a threshold quantity of MIMO layers per CC. However, the network entity 105-a may schedule the UE 115-a with a smaller quantity of MIMO layers than the threshold quantity of MIMO layers (e.g., due to channel conditions of cell loading) for a duration of time. Thus, if the UE 115-a is aware of the scheduling, the UE 115-a may be capable of reusing one or more capabilities of the UE 115-a (e.g., one or more resources) in other dimensions. Similar re-use capabilities may be supported by the UE 115-a for MCS. For example, the network entity 105-a may configure the UE 115-a with a given MCS table, but may schedule the UE 115-a with small MCS indices (e.g., in a subset of the MCS table) for a duration of time.

In some examples, some events may be visible to (e.g. the UE 115-a may be aware of) the UE 115-a based on configuration, activation de-activation, scheduling, or any combination thereof, such as SCell activation, SCell deactivation, SCell dormancy, DRX configuration change, BWP switch, or the like thereof. However, other events, such as gaps in scheduling, a threshold quantity of MIMO layers, MCS, or the like thereof, may not be visible to the UE 115-a (e.g., the UE 115-a may not be aware). Thus, the network entity 105-a may transmit a control message 205 to the UE 115-a to indicate the other events, such that the UE 115-a may re-use one or more resources in different dimensions. That is, the network entity 105-a may transmit the control message 205 indicating the change in scheduling, the change in configuration, or both, of the UE 115-a, such that the UE 115-a may re-use one or more resources in the time domain, the frequency domain, the spatial domain, or any combination thereof. In some examples, the change in scheduling, the change in configuration, or both, may be associated with the time domain (e.g., gaps in scheduling), the frequency domain (e.g., a change in BW), the spatial domain (e.g., the quantity of MIMO layers, MCS), or any combination thereof.

In some examples, the network entity 105-a may indicate one or more time intervals, one or more duty cycles, or both, over which the change in configuration, the change in scheduling, or both, may be valid (e.g., are guaranteed to be kept) for each dimension (e.g., domain). Additionally, or alternatively, the UE 115-a may transmit a request message (e.g., UE assistance information (UAI) signaling) requesting the one or more time intervals, the one or more duty cycles, or both. In such cases, the control message 205 may be an RRC message, a medium access control-control element (MAC-CE), a downlink control information (DCI) message, or any combination thereof. Additionally, or alternatively, the network entity 105-a may indicate one or more respective time intervals, one or more respective duty cycles, for each dimension (e.g., time domain, frequency domain, spatial domain) jointly in a single control message 205 (e.g., the control message 205 or another control message 205) or in multiple control messages 205 (e.g., separately for different dimensions, for different CCs, for downlink, for uplink).

In some examples, the UE 115-a may transmit a capability message 245 indicating one or more candidate adaptions of capabilities (e.g., resources) of the UE 115-a (e.g., reusing one or more capabilities of the UE 115-a in other dimensions) based on receiving the control message 205 indicating the change in scheduling, the change in configuration, or both. In some examples, the one or more candidate adaptions of capabilities may be reported separately for adjustments in the time domain, the frequency domain, and the spatial domain (e.g., and for uplink vs downlink). Additionally, or alternatively, the one or more candidate adaptions of capabilities may be reported with different types (e.g., per BC, per BoBC, per FSPC). In some cases, the one or more candidate adaptions of capabilities may include or exclude some CCs. For example, the UE 115-a may adjust one or more capabilities in a first CC (e.g., CC1) based on a change in scheduling, a change in configuration, or both, in a second CC (e.g., CC2) but not based on a change in scheduling, a change in configuration, or both, in a third CC (e.g., CC3). Additionally, or alternatively, the one or more capabilities may include Or exclude some dimensions. For example, based on a change in the frequency domain in the first CC, the UE 115-a may adapt one or more capabilities in the spatial domain in the second CC, but may not adapt one or more capabilities in the time domain. That is, a time domain change in one CC may translate into a time domain change in another CC.

In some examples, relationships between changes in scheduling, changes in configuration, or both, and adaption of the capabilities (e.g., resources) of the UE 115-a may be signaled between the UE 115-a and the network entity 105-a. In some cases (e.g., on demand), the network entity 105-a may request for the UE 115-a to report one or more updated capabilities based on an indication of a change in configuration, a change in scheduling, or both, of the UE 115-a and based on a time interval associated with the change. In some cases, the request (e.g., and response) may be signaling via RRC signaling, MAC-CE signaling, or DCI (e.g., or uplink control information (UCI)) signaling. Additionally, or alternatively, the request may be specific to a given dimensions or to multiple dimensions. In some examples, the request may include a request if the UE 115-a supports one or more candidate configurations (e.g., specific values). For example, the network entity 105-a may request if the UE 115-a supports 4 layers, or if the UE 115-a supports a BW of X MHz. Additionally, or alternatively (e.g., semi-static, capability based), the UE 115-a may assign a cost (e.g., usage cost) to each dimension (e.g., a quantity of layers in the spatial domain, a BW in the frequency domain, a quantity of consecutive PDSCH/PUSCH in the time domain). In some examples, the cost may additionally be per CC. Additionally, the UE 115-a may support a threshold processing power per CC (e.g., carrier resource unit) and a threshold total processing power across all configured or active CCs of a BC. In some cases, the costs may be transferable across a subset of dimensions and a subset of CCs (e.g., and not all off them). Thus, the network entity 105-a may configure or schedule the UE 115-a as long as the threshold processing power per CC and the threshold total processing power are satisfied.

In some examples (e.g., RF-modem reassignment is capability based), the network entity 105-a may transmit an additional control message 205 indicating how the UE 115-a is to adapt (e.g., adjust) one or more capabilities (e.g., upgrade in some dimensions) based on the change in configuration, the change in scheduling, or both. That is, the additional control message 205 may indicate an adaptation of the one or more capabilities of the UE 115-b based on the change in configuration, the change in scheduling, or both (e.g., previously indicated to the UE 115-a). Conversely, the network entity 105-a may transmit an additional control message 205 indicating not to adjust the one or more capabilities based on the change in configuration, the change in scheduling, or both. In some examples, the additional control message 205 may be transmitted by the network entity 105-a in response to a request from the UE 115-a (e.g., sent via UAI signaling). Additionally, or alternatively, the network entity 105-a may configure the UE 115-a in one of two modes semi-statically. That is, a first mode may be associated with the UE 115-a adapting one or more capabilities based on the change in configuration, the change in scheduling, or both, and a second mode may be associated with the UE 115-a refraining from adapting the one or more capabilities based on the change in configuration, the change in scheduling, or both. In such cases, the network entity 105-a may configure a mode of the UE 115-a (e.g., from the two modes) explicitly (e.g., via RRC, MAC-CE or dynamic signaling) or implicitly (e.g., based on parameters configured for a BWP).

In some examples, the UE 115-a may support a threshold (e.g., minimum) duration for repurposing HW/BB units of the UE 115-a based on the change in configuration, the change in scheduling, or both. In some examples, the threshold duration may be based on a capability of the UE 115-a, based on the change in configuration, the change in scheduling, or both, or both. During the threshold duration after the change in configuration, the change in scheduling, or both, the UE 115-a may not expect to be scheduled by the network entity 105-a (e.g., scheduling may be restricted).

Though described in the context of multi-carrier scenarios (e.g., CA, dual connectivity, dual stack (DS), dual SIM dual active (DSDA)), this is not to be regarded as a limitation of the present disclosure. In this regard, techniques described herein may be supported when the UE 115-a is configured, scheduled, or both, on any quantity of CCs (e.g., including a single CC).

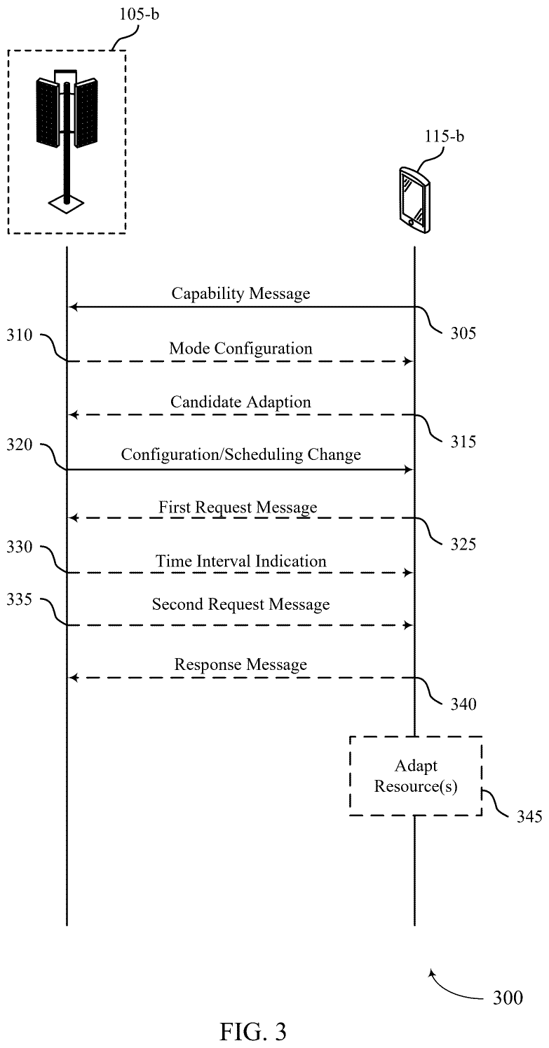

FIG. 3 shows an example of a process flow 300 that supports techniques for re-purposing UE capabilities in time, frequency, and spatial domains in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

At 305, the UE 115-b may transmit a first control message (e.g., capability message) indicative of a capability of the UE 115-b to support re-use of UE resources (e.g., capabilities) across different (e.g., in multiple) dimensions, where the first control message is configured to report capabilities of the UE 115-b to support re-use of UE resources in a time domain, a frequency domain, a spatial domain, or any combination thereof. In some examples, the capability of the UE 115-b to support re-use of UE resources across different dimensions may be reported per domain, per BC, per BoBC, per FSPC, or any combination thereof. In some cases, the first control message may further indicate one or more threshold durations associated with performing resource adaption. In such cases, the one or more threshold durations may be based on a change in configuration or a change in scheduling.

In some cases, at 310, the UE 115-b may receive a second control message indicative of a first mode of the UE 115-b from multiple modes supported by the UE 115-b. In such cases, the multiple modes may include the first mode that indicates that the UE 115-b is to adapt one or more resources based on a change in configuration or a change in scheduling and a second mode that indicates that the UE 115-b is to refrain from adaptation of the one or more resources based on a change in configuration or a change in scheduling.

In some cases, at 315, the UE 115-b may transmit a third control message indicative of multiple candidate adaptions of one or more resources in the time domain, the frequency domain, the spatial domain, or any combination thereof, and usage costs that are individually associated with each candidate adaptation of the multiple candidate adaptations. In some cases, the usage costs may be per CC. Additionally, or alternatively, the third control message may be indicative of a threshold processing power supported by the UE 115-b.

At 320, the UE 115-b may receive a fourth control message indicative of a change in configuration of the UE 115-b, a change in scheduling of the UE 115-b, or both. In some cases, the change in configuration, the change in scheduling, or both, may be based on the usage costs and the threshold processing power. In some examples, the UE 115-b may receive an additional control message (e.g., prior to the third control message) that indicates the UE 115-b is to adapt the one or more resources based on the change in configuration or the change in scheduling. Additionally, or alternatively, the change in configuration or the change in scheduling may be associated with a SCell activation, a SCell deactivation, a cell dormancy, a change in DRX mode configuration, a BWP switch, a change in scheduling gap, a change in a threshold quantity of MIMO layers, a change in MCS, or any combination thereof. In some cases, the change in configuration or the change in scheduling may be associated with the time domain, the frequency domain, the spatial domain, or any combination thereof.

In some cases, at 325, the UE 115-b may transmit a first request message that requests one or more time intervals, one or more duty cycles, or both, associated with the change in configuration or the change in scheduling. Additionally, or alternatively, the first request message may be indicative of a candidate adaption of the one or more resources in the time domain, the frequency domain, the spatial domain, or any combination thereof (e.g., requested by the UE 115-b).

In some cases, at 330, the UE 115-b may receive, via one or more fifth control message (e.g., or the fourth control message), an indication of the one or more time intervals, the one or more duty cycles, or both, associated with the change in configuration or the change in scheduling. In such cases, the one or more time intervals, the one or more duty cycles, or both, may be indicated per domain associated with the change in configuration of the UE 115-b or the change in scheduling of the UE 115-b. In some cases, the one or more fifth control messages may include a single fifth control message that jointly indicates the one or more time intervals, the one or more duty cycles, or both, per domain. Conversely, the one or more fifth control messages may include multiple fifth control messages that separately indicate the one or more time intervals, the one or more duty cycles, or both, per domain.

In some cases, at 335, the UE 115-b may receive a second request message that requests the UE 115-b to report adaptation of the one or more resources, where receiving the request message is based on receiving the fourth control message indicative of the change in configuration, the change in scheduling, or both. In some cases, the second request message may request the UE 115-b to report the adaptation of the one or more resources in at least one of the time domain, the frequency domain, and the spatial domain. Additionally, or alternatively, the second request message may be indicative of a candidate adaptation of the one or more resources.

In some cases, at 340, the UE 115-b may transmit a response message indicative of an adaption of the one or more resources.

At 345, the UE 115-b may adapt the one or more resources in the time domain, the frequency domain, the spatial domain, or any combination thereof, in accordance with the change in configuration or the change in scheduling based on the capability of the UE 115-b to support re-use of UE resources across different dimensions. In some cases, the adaption may be based on transmitting the response message.

In some cases, the change in configuration or the change in scheduling may be associated with a first CC of multiple CCs supported by the UE 115-b, such that the adaptation of the one or more resources may be associated with one or more second CCs of the multiple CCs based on the change in configuration or the change in scheduling being associated with the first CC.

In some examples, the change in configuration or the change in scheduling may be associated with a first domain of multiple domains including the time domain, the frequency domain, and the spatial domain, such that the adaptation of the one or more resources may be associated with one or more second domains of the multiple domains based on the change in configuration or the change in scheduling being associated with the first domain. In some cases, the first domain and at least one of the one or more second domains may be a same domain. Conversely, in some cases, the first domain and the one or more second domains may be different domains.

In some cases, the adaption of the one or more resources may be based on an additional control message received from the network entity 105-b indicative of the adaption. Additionally, or alternatively, the adaption of the one or more resources may be based on a first relationship between the change in configuration or the change in scheduling and the adaption of the one or more resources. That is, the UE 115-b may receive (e.g., prior to the third control message) indictive of multiple relationships between multiple changes in configurations, multiple changes in scheduling, or both, and multiple adaptions of the one or more resources, where the multiple relationships includes the first relationship.

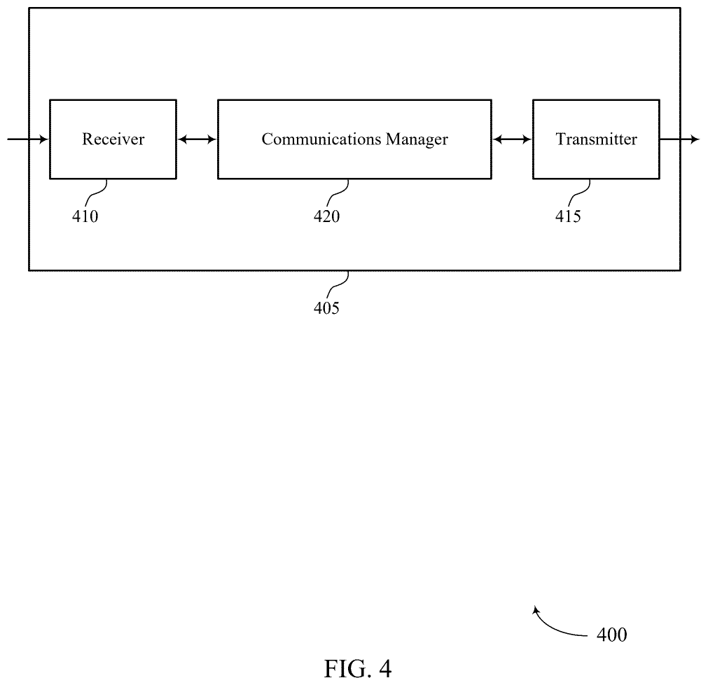

FIG. 4 shows a block diagram 400 of a device 405 that supports techniques for re-purposing UE capabilities in time, frequency, and spatial domains in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for re-purposing UE capabilities in time, frequency, and spatial domains). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for re-purposing UE capabilities in time, frequency, and spatial domains). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for re-purposing UE capabilities in time, frequency, and spatial domains as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof. The communications manager 420 is capable of, configured to, or operable to support a means for receiving a second control message indicative of a change in configuration of the UE or a change in scheduling of the UE. The communications manager 420 is capable of, configured to, or operable to support a means for adapting one or more resources in the time domain, the frequency domain, the spatial domain, or any combination thereof, in accordance with the change in configuration or the change in scheduling based on the capability of the UE to support re-use of UE resources across different dimensions.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for re-use of UE resources across different dimensions, which may result in reduced processing, reduced power consumption, and more efficient utilization of communication resources.

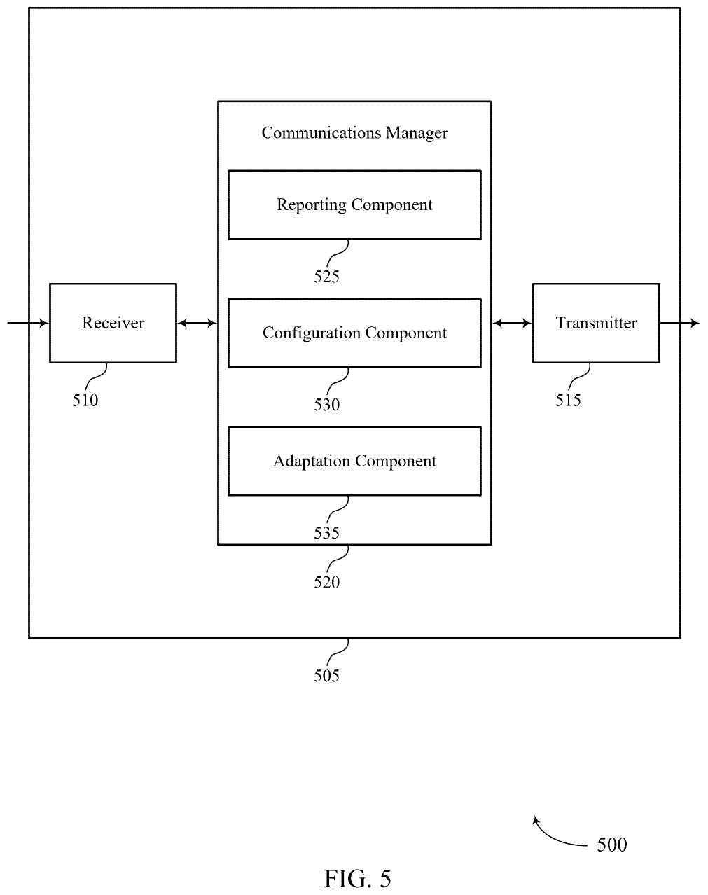

FIG. 5 shows a block diagram 500 of a device 505 that supports techniques for re-purposing UE capabilities in time, frequency, and spatial domains in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for re-purposing UE capabilities in time, frequency, and spatial domains). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for re-purposing UE capabilities in time, frequency, and spatial domains). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for re-purposing UE capabilities in time, frequency, and spatial domains as described herein. For example, the communications manager 520 may include a reporting component 525, a configuration component 530, an adaptation component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The reporting component 525 is capable of, configured to, or operable to support a means for transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof. The configuration component 530 is capable of, configured to, or operable to support a means for receiving a second control message indicative of a change in configuration of the UE or a change in scheduling of the UE. The adaptation component 535 is capable of, configured to, or operable to support a means for adapting one or more resources in the time domain, the frequency domain, the spatial domain, or any combination thereof, in accordance with the change in configuration or the change in scheduling based on the capability of the UE to support re-use of UE resources across different dimensions.

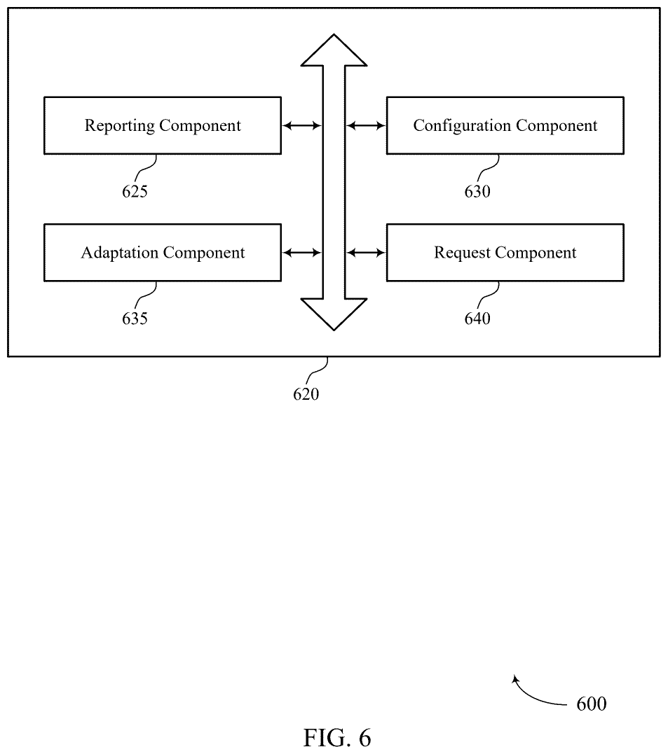

FIG. 6 shows a block diagram 600 of a communications manager 620 that supports techniques for re-purposing UE capabilities in time, frequency, and spatial domains in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for re-purposing UE capabilities in time, frequency, and spatial domains as described herein. For example, the communications manager 620 may include a reporting component 625, a configuration component 630, an adaptation component 635, a request component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The reporting component 625 is capable of, configured to, or operable to support a means for transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof. The configuration component 630 is capable of, configured to, or operable to support a means for receiving a second control message indicative of a change in configuration of the UE or a change in scheduling of the UE. The adaptation component 635 is capable of, configured to, or operable to support a means for adapting one or more resources in the time domain, the frequency domain, the spatial domain, or any combination thereof, in accordance with the change in configuration or the change in scheduling based on the capability of the UE to support re-use of UE resources across different dimensions.

In some examples, the configuration component 630 is capable of, configured to, or operable to support a means for receiving one or more third control messages indicative of one or more time intervals, one or more duty cycles, or both, associated with the change in configuration or the change in scheduling, where adaptation of the one or more resources is based on the one or more time intervals, the one or more duty cycles, or both.

In some examples, the request component 640 is capable of, configured to, or operable to support a means for transmitting a request message that requests the one or more time intervals, the one or more duty cycles, or both, associated with the change in configuration or the change in scheduling, where receiving the one or more third control messages is based on transmitting the request message.

In some examples, the one or more time intervals, the one or more duty cycles, or both, are indicated per domain associated with the change in configuration of the UE or the change in scheduling of the UE.

In some examples, the one or more third control messages include a single third control message. In some examples, the single third control message jointly indicates the one or more time intervals, the one or more duty cycles, or both, per domain.

In some examples, the one or more third control messages include a set of multiple third control messages. In some examples, the set of multiple third control messages separately indicate the one or more time intervals, the one or more duty cycles, or both, per domain.

In some examples, the one or more third control messages include a single third control message. In some examples, the single third control message is a same control message as the second control message.

In some examples, the capability of the UE to support re-use of UE resources across different dimensions is reported per domain, per band combination, per band per band combination, per feature set per component carrier, or any combination thereof.

In some examples, the change in configuration or the change in scheduling is associated with a first component carrier of a set of multiple component carriers supported by the UE. In some examples, the adaptation of the one or more resources is associated with one or more second component carrier of the set of multiple component carriers based on the change in configuration or the change in scheduling being associated with the first component carrier of the set of multiple component carriers.

In some examples, the change in configuration or the change in scheduling is associated with a first domain of a set of multiple domains including the time domain, the frequency domain, and the spatial domain. In some examples, the adaptation of the one or more resources is associated with one or more second domains of the set of multiple domains based on the change in configuration or the change in scheduling being associated with the first domain of the set of multiple domains.

In some examples, the first domain and at least a one of the one or more second domains are a same domain.

In some examples, the first domain and the one or more second domains are different domains.

In some examples, the request component 640 is capable of, configured to, or operable to support a means for receiving a request message that requests the UE to report the adaptation of the one or more resources, where receiving the request message is based on receiving the second control message. In some examples, the reporting component 625 is capable of, configured to, or operable to support a means for transmitting a response message indicative of the adaptation of the one or more resources, where adapting the one or more resources is based on transmitting the response message.

In some examples, the request message requests the UE to report the adaptation of the one or more resources in at least one of the time domain, the frequency domain, and the spatial domain.

In some examples, the request message is indicative of a candidate adaptation of the one or more resources. In some examples, the response message is indicative of whether the UE is able to support the candidate adaptation.

In some examples, the reporting component 625 is capable of, configured to, or operable to support a means for transmitting a third control message indicative of a set of multiple a candidate adaptations of the one or more resources in the time domain, the frequency domain, the spatial domain, or any combination thereof, and usage costs that are individually associated with each candidate adaptation of the set of multiple candidate adaptations, where the change in configuration of the UE or the change in scheduling of the UE is based on the usage costs.

In some examples, the usage costs are per component carrier.

In some examples, the third control message is indicative of a threshold processing power supported by the UE. In some examples, the change in configuration or the change in scheduling is based on the threshold processing power supported by the UE.

In some examples, the configuration component 630 is capable of, configured to, or operable to support a means for receiving a third control message indicative of a first mode of the UE of a set of multiple modes supported by the UE, where the set of multiple modes includes the first mode that indicates that the UE is to adapt the one or more resources based on the change in configuration or the change in scheduling and a second mode that indicates that the UE is to refrain from adaptation of the one or more resources.

In some examples, the adaptation component 635 is capable of, configured to, or operable to support a means for receiving a third control message that indicates that the UE is to adapt the one or more resources based on the change in configuration or the change in scheduling.

In some examples, the adaptation component 635 is capable of, configured to, or operable to support a means for receiving a third control message indicative of the adaptation of the one or more resources in the time domain, the frequency domain, the spatial domain, or any combination thereof, where adaptation of the one or more resources is based on receiving the third control message.

In some examples, the request component 640 is capable of, configured to, or operable to support a means for transmitting a request message indicative of a candidate adaptation of the one or more resources in the time domain, the frequency domain, the spatial domain, or any combination thereof, where receiving the third control message is based on transmitting the request message, and where the adaptation of the one or more resources is based on the candidate adaptation of the one or more resources requested by the UE.

In some examples, the configuration component 630 is capable of, configured to, or operable to support a means for receiving a third control message indicative of a set of multiple relationships between a set of multiple changes in configuration of the UE, a set of multiple changes in scheduling of the UE, or both, and a set of multiple adaptations of the one or more resources in the time domain, the frequency domain, the spatial domain, or any combination thereof, where adaptation of the one or more resources is based on the set of multiple relationships.

In some examples, the first control message further indicates one or more threshold durations associated with performing resource adaptation. In some examples, adaptation of the one or more resources is based on the one or more threshold durations.

In some examples, the one or more threshold durations are based on the change in configuration or the change in scheduling.

In some examples, the change in configuration or the change in scheduling is associated with a secondary cell activation, a secondary cell deactivation, a cell dormancy, a change in discontinuous reception mode configuration, a bandwidth part switch, a change in scheduling gap, a change in a threshold quantity of multiple input multiple output layers, a change in modulation and coding scheme, or any combination thereof.

In some examples, the change in configuration of the UE or the change in scheduling of the UE is associated with the time domain, the frequency domain, the spatial domain, or any combination thereof.

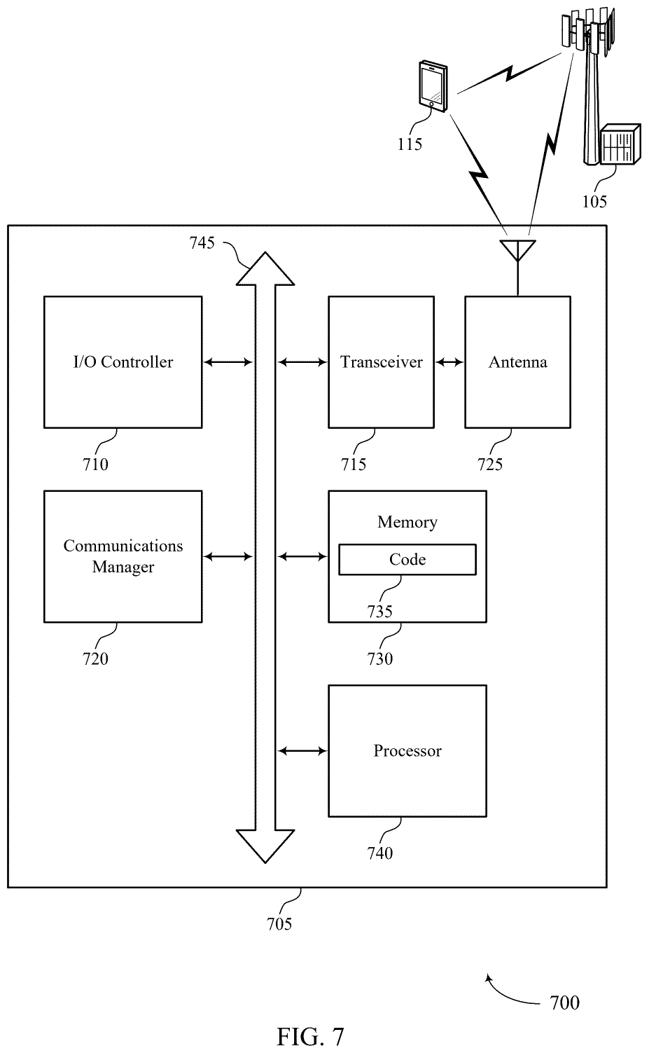

FIG. 7 shows a diagram of a system 700 including a device 705 that supports techniques for re-purposing UE capabilities in time, frequency, and spatial domains in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for re-purposing UE capabilities in time, frequency, and spatial domains). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof. The communications manager 720 is capable of, configured to, or operable to support a means for receiving a second control message indicative of a change in configuration of the UE or a change in scheduling of the UE. The communications manager 720 is capable of, configured to, or operable to support a means for adapting one or more resources in the time domain, the frequency domain, the spatial domain, or any combination thereof, in accordance with the change in configuration or the change in scheduling based on the capability of the UE to support re-use of UE resources across different dimensions.

By including or configuring the communications manager 720 in accordance with examples as described herein, the device 705 may support techniques for re-use of UE resources across different dimensions, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for re-purposing UE capabilities in time, frequency, and spatial domains as described herein, or the at least one processor 740 and the at least one memory 730 may be otherwise configured to, individually or collectively, perform or support such operations.

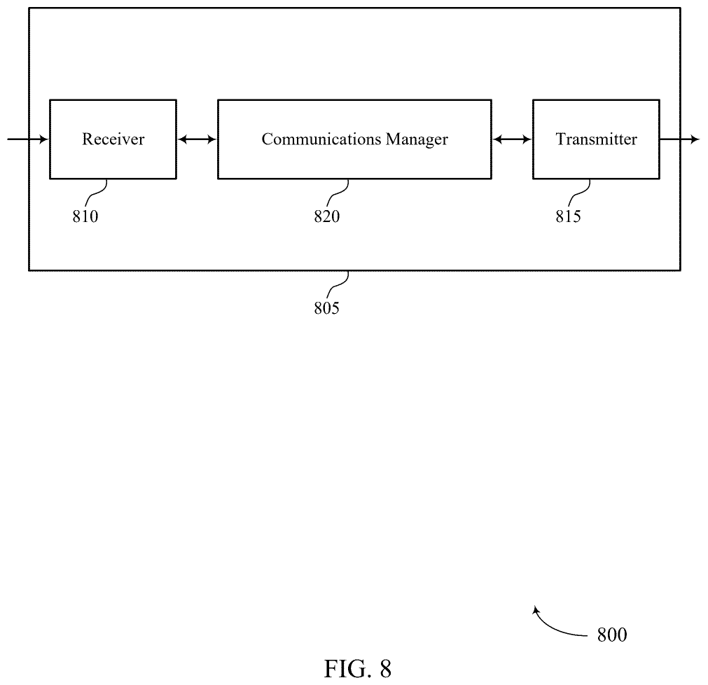

FIG. 8 shows a block diagram 800 of a device 805 that supports techniques for re-purposing UE capabilities in time, frequency, and spatial domains in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for re-purposing UE capabilities in time, frequency, and spatial domains as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a first control message indicative of a capability of a UE to support re-use of UE resources across different dimensions, where the first control message is configured to report capabilities of the UE to support re-use of UE resources in a time domain, a frequency domain, a spatial domain, or any combination thereof. The communications manager 820 is capable of, configured to, or operable to support a means for transmitting a second control message indicative of a change in configuration of the UE or a change in scheduling of the UE. The communications manager 820 is capable of, configured to, or operable to support a means for communicating with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for re-use of UE resources across different dimensions, which may result in reduced processing, reduced power consumption, and more efficient utilization of communication resources, among other advantages.

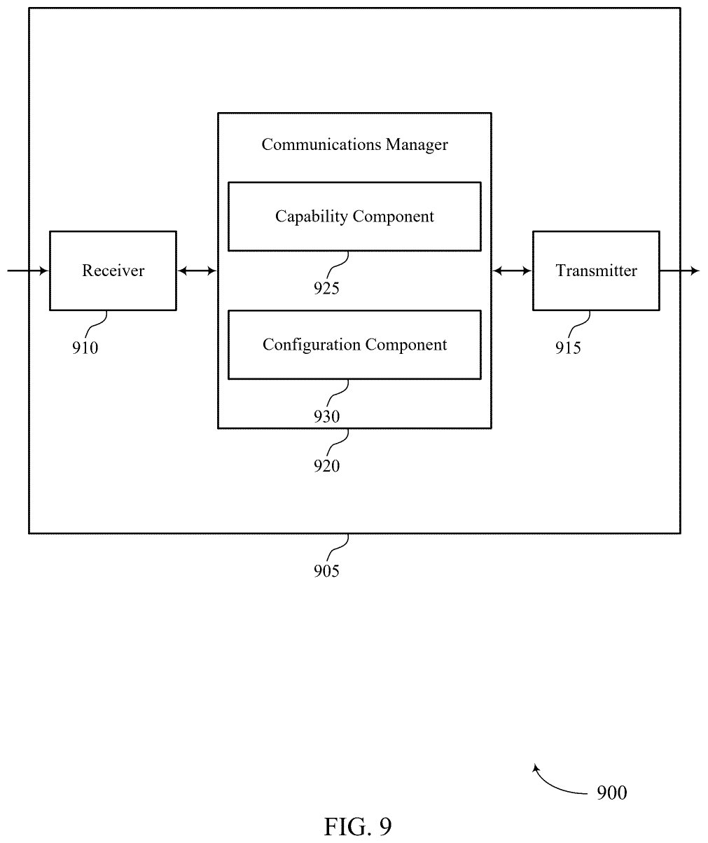

FIG. 9 shows a block diagram 900 of a device 905 that supports techniques for re-purposing UE capabilities in time, frequency, and spatial domains in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for re-purposing UE capabilities in time, frequency, and spatial domains as described herein. For example, the communications manager 920 may include a capability component 925 a configuration component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The capability component 925 is capable of, configured to, or operable to support a means for receiving a first control message indicative of a capability of a UE to support re-use of UE resources across different dimensions, where the first control message is configured to report capabilities of the UE to support re-use of UE resources in a time domain, a frequency domain, a spatial domain, or any combination thereof. The configuration component 930 is capable of, configured to, or operable to support a means for transmitting a second control message indicative of a change in configuration of the UE or a change in scheduling of the UE. The configuration component 930 is capable of, configured to, or operable to support a means for communicating with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

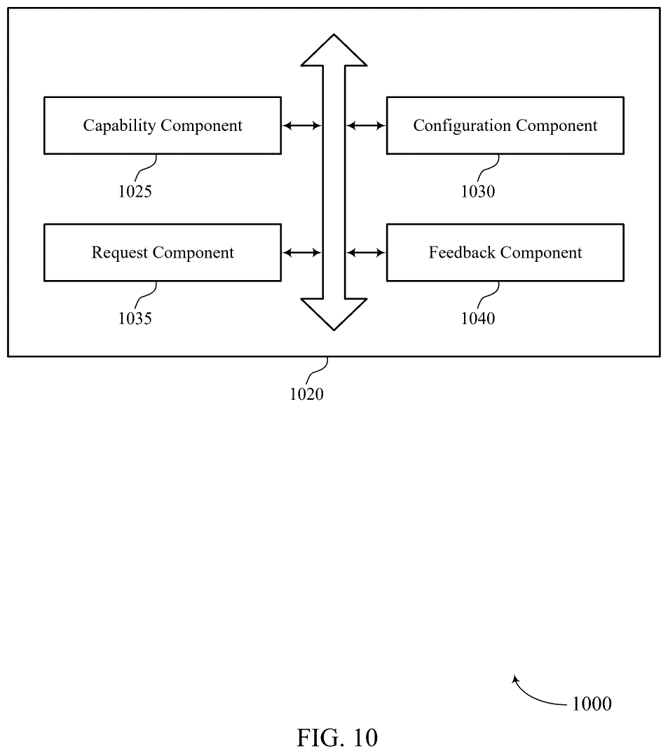

FIG. 10 shows a block diagram 1000 of a communications manager 1020 that supports techniques for re-purposing UE capabilities in time, frequency, and spatial domains in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for re-purposing UE capabilities in time, frequency, and spatial domains as described herein. For example, the communications manager 1020 may include a capability component 1025, a configuration component 1030, a request component 1035, a feedback component 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The capability component 1025 is capable of, configured to, or operable to support a means for receiving a first control message indicative of a capability of a UE to support re-use of UE resources across different dimensions, where the first control message is configured to report capabilities of the UE to support re-use of UE resources in a time domain, a frequency domain, a spatial domain, or any combination thereof. The configuration component 1030 is capable of, configured to, or operable to support a means for transmitting a second control message indicative of a change in configuration of the UE or a change in scheduling of the UE. In some examples, the configuration component 1030 is capable of, configured to, or operable to support a means for communicating with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

In some examples, the configuration component 1030 is capable of, configured to, or operable to support a means for transmitting one or more third control messages indicative of one or more time intervals, one or more duty cycles, or both, associated with the change in configuration or the change in scheduling, where adaptation of the one or more resources is based on the one or more time intervals, the one or more duty cycles, or both.

In some examples, the request component 1035 is capable of, configured to, or operable to support a means for receiving a request message that requests the one or more time intervals, the one or more duty cycles, or both, associated with the change in configuration or the change in scheduling, where receiving the one or more third control messages is based on transmitting the request message.

In some examples, the one or more time intervals, the one or more duty cycles, or both, are indicated per domain associated with the change in configuration of the UE or the change in scheduling of the UE.

In some examples, the one or more third control messages include a single third control message. In some examples, the single third control message jointly indicates the one or more time intervals, the one or more duty cycles, or both, per domain.

In some examples, the one or more third control messages include a set of multiple third control messages. In some examples, the set of multiple third control messages separately indicate the one or more time intervals, the one or more duty cycles, or both, per domain.

In some examples, the one or more third control messages include a single third control message. In some examples, the single third control message is a same control message as the second control message.

In some examples, the capability of the UE to support re-use of UE resources across different dimensions is reported per domain, per band combination, per band per band combination, per feature set per component carrier, or any combination thereof.

In some examples, the change in configuration or the change in scheduling is associated with a first component carrier of a set of multiple component carriers supported by the UE. In some examples, the adaptation of the one or more resources is associated with one or more second component carrier of the set of multiple component carriers based on the change in configuration or the change in scheduling being associated with the first component carrier of the set of multiple component carriers.

In some examples, the change in configuration or the change in scheduling is associated with a first domain of a set of multiple domains including the time domain, the frequency domain, and the spatial domain. In some examples, the adaptation of the one or more resources is associated with one or more second domains of the set of multiple domains based on the change in configuration or the change in scheduling being associated with the first domain of the set of multiple domains.

In some examples, the first domain and at least a one of the one or more second domains are a same domain.

In some examples, the first domain and the one or more second domains are different domains.

In some examples, the request component 1035 is capable of, configured to, or operable to support a means for transmitting a request message that requests the UE to report the adaptation of the one or more resources, where receiving the request message is based on receiving the second control message. In some examples, the feedback component 1040 is capable of, configured to, or operable to support a means for receiving a response message indicative of the adaptation of the one or more resources, where adapting the one or more resources is based on transmitting the response message.

In some examples, the request message requests the UE to report the adaptation of the one or more resources in at least one of the time domain, the frequency domain, and the spatial domain.

In some examples, the request message is indicative of a candidate adaptation of the one or more resources. In some examples, the response message is indicative of whether the UE is able to support the candidate adaptation.

In some examples, the capability component 1025 is capable of, configured to, or operable to support a means for receiving a third control message indicative of a set of multiple a candidate adaptations of the one or more resources in the time domain, the frequency domain, the spatial domain, or any combination thereof, and usage costs that are individually associated with each candidate adaptation of the set of multiple candidate adaptations, where the change in configuration of the UE or the change in scheduling of the UE is based on the usage costs.

In some examples, the usage costs are per component carrier.

In some examples, the third control message is indicative of a threshold processing power supported by the UE. In some examples, the change in configuration or the change in scheduling is based on the threshold processing power supported by the UE.

In some examples, the configuration component 1030 is capable of, configured to, or operable to support a means for transmitting a third control message indicative of a first mode of the UE of a set of multiple modes supported by the UE, where the set of multiple modes includes the first mode that indicates that the UE is to adapt the one or more resources based on the change in configuration or the change in scheduling and a second mode that indicates that the UE is to refrain from adaptation of the one or more resources.

In some examples, the configuration component 1030 is capable of, configured to, or operable to support a means for transmitting a third control message that indicates that the UE is to adapt the one or more resources based on the change in configuration or the change in scheduling.

In some examples, the feedback component 1040 is capable of, configured to, or operable to support a means for transmitting a third control message indicative of the adaptation of the one or more resources in the time domain, the frequency domain, the spatial domain, or any combination thereof, where adaptation of the one or more resources is based on receiving the third control message.

In some examples, the capability component 1025 is capable of, configured to, or operable to support a means for receiving a request message indicative of a candidate adaptation of the one or more resources in the time domain, the frequency domain, the spatial domain, or any combination thereof, where receiving the third control message is based on transmitting the request message, and where the adaptation of the one or more resources is based on the candidate adaptation of the one or more resources requested by the UE.

In some examples, the configuration component 1030 is capable of, configured to, or operable to support a means for transmitting a third control message indicative of a set of multiple relationships between a set of multiple changes in configuration of the UE, a set of multiple changes in scheduling of the UE, or both, and a set of multiple adaptations of the one or more resources in the time domain, the frequency domain, the spatial domain, or any combination thereof, where adaptation of the one or more resources is based on the set of multiple relationships.

In some examples, the first control message further indicates one or more threshold durations associated with performing resource adaptation. In some examples, adaptation of the one or more resources is based on the one or more threshold durations.

In some examples, the one or more threshold durations are based on the change in configuration or the change in scheduling.

In some examples, the change in configuration or the change in scheduling is associated with a secondary cell activation, a secondary cell deactivation, a cell dormancy, a change in discontinuous reception mode configuration, a bandwidth part switch, a change in scheduling gap, a change in a threshold quantity of multiple input multiple output layers, a change in modulation and coding scheme, or any combination thereof.

In some examples, the change in configuration of the UE or the change in scheduling of the UE is associated with the time domain, the frequency domain, the spatial domain, or any combination thereof.

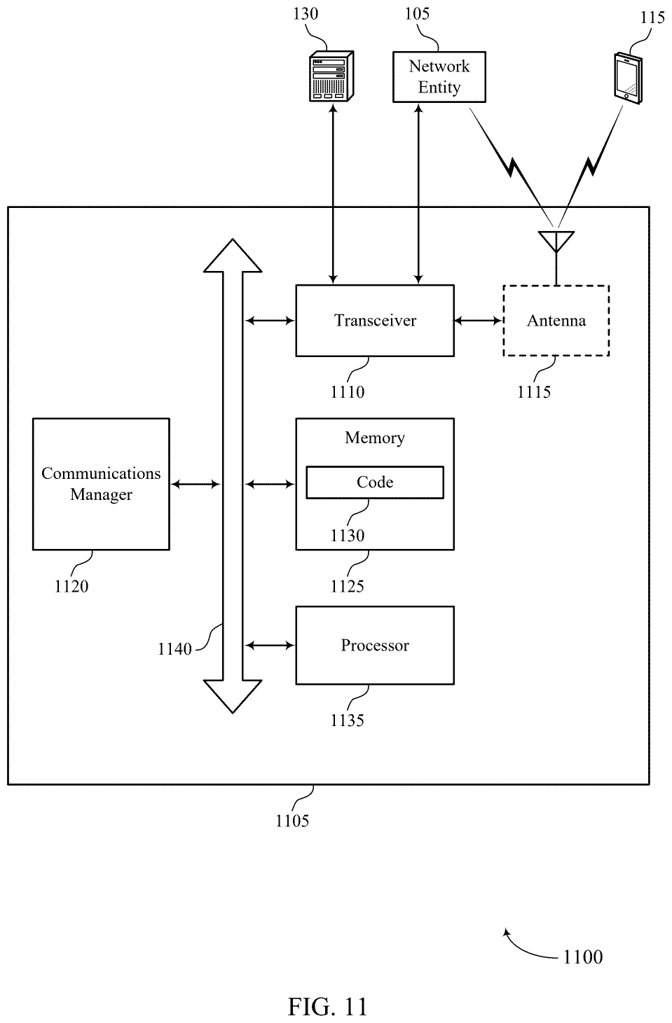

FIG. 11 shows a diagram of a system 1100 including a device 1105 that supports techniques for re-purposing UE capabilities in time, frequency, and spatial domains in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for re-purposing UE capabilities in time, frequency, and spatial domains). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for receiving a first control message indicative of a capability of the UE to support re-use of UE resources across different dimensions, where the first control message is configured to report capabilities of the UE to support re-use of UE resources in a time domain, a frequency domain, a spatial domain, or any combination thereof. The communications manager 1120 is capable of, configured to, or operable to support a means for transmitting a second control message indicative of a change in configuration of the UE or a change in scheduling of the UE. The communications manager 1120 is capable of, configured to, or operable to support a means for communicating with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions.

By including or configuring the communications manager 1120 in accordance with examples as described herein, the device 1105 may support techniques for re-use of UE resources across different dimensions, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for re-purposing UE capabilities in time, frequency, and spatial domains as described herein, or the at least one processor 1135 and the at least one memory 1125 may be otherwise configured to, individually or collectively, perform or support such operations.

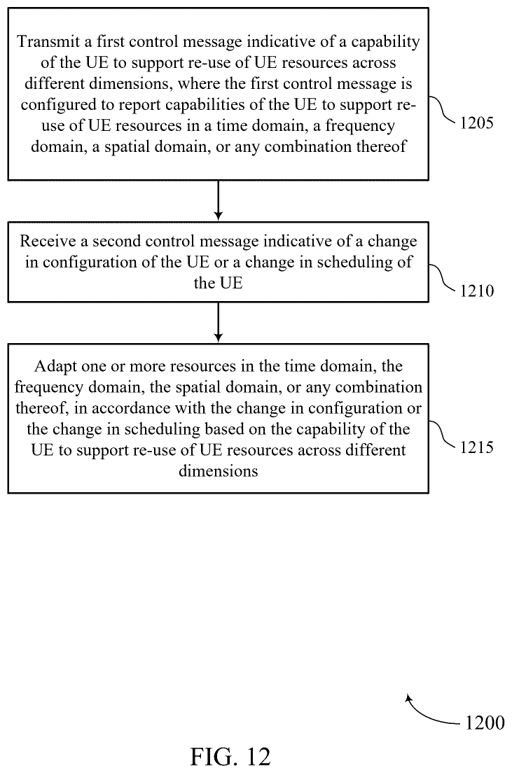

FIG. 12 shows a flowchart illustrating a method 1200 that supports techniques for re-purposing UE capabilities in time, frequency, and spatial domains in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof. The operations of 1205 may be performed in accordance with examples as disclosed herein. In some examples, aspects of the operations of 1205 may be performed by a reporting component 625 as described with reference to FIG. 6.

At 1210, the method may include receiving a second control message indicative of a change in configuration of the UE or a change in scheduling of the UE. The operations of 1210 may be performed in accordance with examples as disclosed herein. In some examples, aspects of the operations of 1210 may be performed by a configuration component 630 as described with reference to FIG. 6.

At 1215, the method may include adapting one or more resources in the time domain, the frequency domain, the spatial domain, or any combination thereof, in accordance with the change in configuration or the change in scheduling based on the capability of the UE to support re-use of UE resources across different dimensions. The operations of 1215 may be performed in accordance with examples as disclosed herein. In some examples, aspects of the operations of 1215 may be performed by an adaptation component 635 as described with reference to FIG. 6.

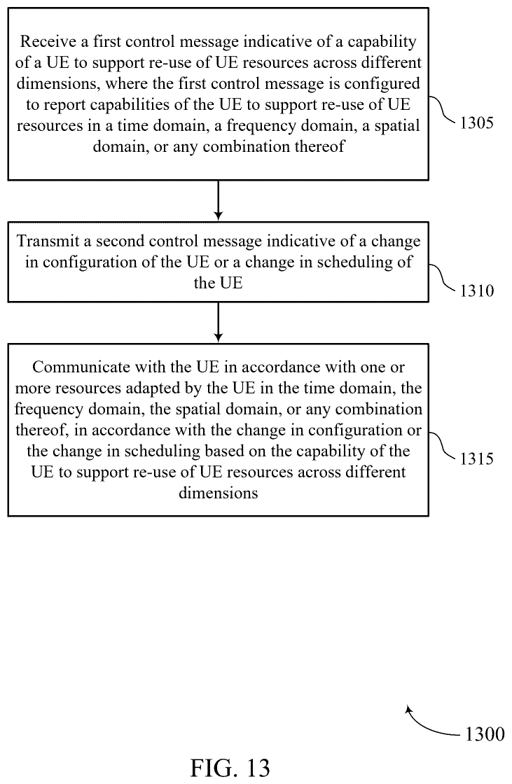

FIG. 13 shows a flowchart illustrating a method 1300 that supports techniques for re-purposing UE capabilities in time, frequency, and spatial domains in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include receiving a first control message indicative of a capability of a UE to support re-use of UE resources across different dimensions, where the first control message is configured to report capabilities of the UE to support re-use of UE resources in a time domain, a frequency domain, a spatial domain, or any combination thereof. The operations of 1305 may be performed in accordance with examples as disclosed herein. In some examples, aspects of the operations of 1305 may be performed by a capability component 1025 as described with reference to FIG. 10.

At 1310, the method may include transmitting a second control message indicative of a change in configuration of the UE or a change in scheduling of the UE. The operations of 1310 may be performed in accordance with examples as disclosed herein. In some examples, aspects of the operations of 1310 may be performed by a configuration component 1030 as described with reference to FIG. 10.

At 1315, the method may include communicating with the UE in accordance with one or more resources adapted by the UE in the time domain, the frequency domain, the spatial domain, or any combination thereof, in accordance with the change in configuration or the change in scheduling based on the capability of the UE to support re-use of UE resources across different dimensions. The operations of 1315 may be performed in accordance with examples as disclosed herein. In some examples, aspects of the operations of 1315 may be performed by a configuration component 1030 as described with reference to FIG. 10.

The following provides an overview of aspects of the present disclosure:

Aspect 1: A method for wireless communications at a UE, comprising: transmitting a first control message indicative of a capability of the UE to support re-use of UE resources across different dimensions, where the first control message is configured to report capabilities of the UE to support re-use of UE resources in a time domain, a frequency domain, a spatial domain, or any combination thereof; receiving a second control message indicative of a change in configuration of the UE or a change in scheduling of the UE; and adapting one or more resources in the time domain, the frequency domain, the spatial domain, or any combination thereof, in accordance with the change in configuration or the change in scheduling based at least in part on the capability of the UE to support re-use of UE resources across different dimensions.

Aspect 2: The method of aspect 1, further comprising: receiving one or more third control messages indicative of one or more time intervals, one or more duty cycles, or both, associated with the change in configuration or the change in scheduling, wherein adaptation of the one or more resources is based at least in part on the one or more time intervals, the one or more time duty cycles, or both.

Aspect 3: The method of aspect 2, further comprising: transmitting a request message that requests the one or more time intervals, the one or more time duty cycles, or both, associated with the change in configuration or the change in scheduling, wherein receiving the one or more third control messages is based at least in part on transmitting the request message.

Aspect 4: The method of any of aspects 2 through 3, wherein the one or more time intervals, the one or more time duty cycles, or both, are indicated per domain associated with the change in configuration of the UE or the change in scheduling of the UE.

Aspect 5: The method of aspect 4, wherein the one or more third control messages comprise a single third control message, and the single third control message jointly indicates the one or more time intervals, the one or more time duty cycles, or both, per domain.

Aspect 6: The method of any of aspects 4 through 5, wherein the one or more third control messages comprise a plurality of third control messages, and the plurality of third control messages separately indicate the one or more time intervals, the one or more time duty cycles, or both, per domain.

Aspect 7: The method of any of aspects 2 through 6, wherein the one or more third control messages comprise a single third control message, and the single third control message is a same control message as the second control message.

Aspect 8: The method of any of aspects 1 through 7, wherein the capability of the UE to support re-use of UE resources across different dimensions is reported per domain, per band combination, per band per band combination, per feature set per CC, or any combination thereof.

Aspect 9: The method of any of aspects 1 through 8, wherein the change in configuration or the change in scheduling is associated with a first CC of a plurality of CCs supported by the UE, and the adaptation of the one or more resources is associated with one or more second CC of the plurality of CCs based at least in part on the change in configuration or the change in scheduling being associated with the first CC of the plurality of CCs.

Aspect 10: The method of any of aspects 1 through 9, wherein the change in configuration or the change in scheduling is associated with a first domain of a plurality of domains comprising the time domain, the frequency domain, and the spatial domain, and the adaptation of the one or more resources is associated with one or more second domains of the plurality of domains based at least in part on the change in configuration or the change in scheduling being associated with the first domain of the plurality of domains.

Aspect 11: The method of aspect 10, wherein the first domain and at least a one of the one or more second domains are a same domain.

Aspect 12: The method of any of aspects 10 through 11, wherein the first domain and the one or more second domains are different domains.

Aspect 13: The method of any of aspects 1 through 12, further comprising: receiving a request message that requests the UE to report the adaptation of the one or more resources, wherein receiving the request message is based at least in part on receiving the second control message; and transmitting a response message indicative of the adaptation of the one or more resources, wherein adapting the one or more resources is based at least in part on transmitting the response message.

Aspect 14: The method of aspect 13, wherein the request message requests the UE to report the adaptation of the one or more resources in at least one of the time domain, the frequency domain, and the spatial domain.

Aspect 15: The method of any of aspects 13 through 14, wherein the request message is indicative of a candidate adaptation of the one or more resources, and the response message is indicative of whether the UE is able to support the candidate adaptation.

Aspect 16: The method of any of aspects 1 through 15, further comprising: transmitting a third control message indicative of a plurality of a candidate adaptations of the one or more resources in the time domain, the frequency domain, the spatial domain, or any combination thereof, and usage costs that are individually associated with each candidate adaptation of the plurality of candidate adaptations, wherein the change in configuration of the UE or the change in scheduling of the UE is based at least in part on the usage costs.

Aspect 17: The method of aspect 16, wherein the usage costs are per CC.

Aspect 18: The method of any of aspects 16 through 17, wherein the third control message is indicative of a threshold processing power supported by the UE, and the change in configuration or the change in scheduling is based at least in part on the threshold processing power supported by the UE.

Aspect 19: The method of any of aspects 1 through 18, further comprising: receiving a third control message indicative of a first mode of the UE of a plurality of modes supported by the UE, wherein the plurality of modes comprises the first mode that indicates that the UE is to adapt the one or more resources based at least in part on the change in configuration or the change in scheduling and a second mode that indicates that the UE is to refrain from adaptation of the one or more resources.

Aspect 20: The method of any of aspects 1 through 19, further comprising: receiving a third control message that indicates that the UE is to adapt the one or more resources based at least in part on the change in configuration or the change in scheduling.

Aspect 21: The method of any of aspects 1 through 20, further comprising: receiving a third control message indicative of the adaptation of the one or more resources in the time domain, the frequency domain, the spatial domain, or any combination thereof, wherein adaptation of the one or more resources is based at least in part on receiving the third control message.

Aspect 22: The method of aspect 21, further comprising: transmitting a request message indicative of a candidate adaptation of the one or more resources in the time domain, the frequency domain, the spatial domain, or any combination thereof, wherein receiving the third control message is based at least in part on transmitting the request message, and wherein the adaptation of the one or more resources is based at least in part on the candidate adaptation of the one or more resources requested by the UE.

Aspect 23: The method of any of aspects 1 through 22, further comprising: receiving a third control message indicative of a plurality of relationships between a plurality of changes in configuration of the UE, a plurality of changes in scheduling of the UE, or both, and a plurality of adaptations of the one or more resources in the time domain, the frequency domain, the spatial domain, or any combination thereof, wherein adaptation of the one or more resources is based at least in part on the plurality of relationships.

Aspect 24: The method of any of aspects 1 through 23, wherein the first control message further indicates one or more threshold durations associated with performing resource adaptation, and adaptation of the one or more resources is based at least in part on the one or more threshold durations.

Aspect 25: The method of aspect 24, wherein the one or more threshold durations are based at least in part on the change in configuration or the change in scheduling.

Aspect 26: The method of any of aspects 1 through 25, wherein the change in configuration or the change in scheduling is associated with a SCell activation, a SCell deactivation, a cell dormancy, a change in DRX mode configuration, a BWP switch, a change in scheduling gap, a change in a threshold quantity of MIMO layers, a change in MCS, or any combination thereof.

Aspect 27: The method of any of aspects 1 through 26, wherein the change in configuration of the UE or the change in scheduling of the UE is associated with the time domain, the frequency domain, the spatial domain, or any combination thereof.

Aspect 28: A method for wireless communications at a network entity, comprising: receiving a first control message indicative of a capability of a UE to support re-use of UE resources across different dimensions, where the first control message is configured to report capabilities of the UE to support re-use of UE resources in a time domain, a frequency domain, a spatial domain, or any combination thereof; transmitting a second control message indicative of a change in configuration of the UE or a change in scheduling of the UE; and communicating with the UE in accordance with one or more resources adapted by the UE in the time domain, the frequency domain, the spatial domain, or any combination thereof, in accordance with the change in configuration or the change in scheduling based at least in part on the capability of the UE to support re-use of UE resources across different dimensions.

Aspect 29: The method of aspect 28, further comprising: transmitting one or more third control messages indicative of one or more time intervals, one or more duty cycles, or both, associated with the change in configuration or the change in scheduling, wherein adaptation of the one or more resources is based at least in part on the one or more time intervals, the one or more time duty cycles, or both.

Aspect 30: The method of aspect 29, further comprising: receiving a request message that requests the one or more time intervals, the one or more time duty cycles, or both, associated with the change in configuration or the change in scheduling, wherein receiving the one or more third control messages is based at least in part on transmitting the request message.

Aspect 31: The method of any of aspects 29 through 30, wherein the one or more time intervals, the one or more time duty cycles, or both, are indicated per domain associated with the change in configuration of the UE or the change in scheduling of the UE.

Aspect 32: The method of aspect 31, wherein the one or more third control messages comprise a single third control message, and the single third control message jointly indicates the one or more time intervals, the one or more time duty cycles, or both, per domain.

Aspect 33: The method of any of aspects 31 through 32, wherein the one or more third control messages comprise a plurality of third control messages, and the plurality of third control messages separately indicate the one or more time intervals, the one or more time duty cycles, or both, per domain.

Aspect 34: The method of any of aspects 29 through 33, wherein the one or more third control messages comprise a single third control message, and the single third control message is a same control message as the second control message.

Aspect 35: The method of any of aspects 28 through 34, wherein the capability of the UE to support re-use of UE resources across different dimensions is reported per domain, per band combination, per band per band combination, per feature set per CC, or any combination thereof.

Aspect 36: The method of any of aspects 28 through 35, wherein the change in configuration or the change in scheduling is associated with a first CC of a plurality of CCs supported by the UE, and the adaptation of the one or more resources is associated with one or more second CC of the plurality of CCs based at least in part on the change in configuration or the change in scheduling being associated with the first CC of the plurality of CCs.

Aspect 37: The method of any of aspects 28 through 36, wherein the change in configuration or the change in scheduling is associated with a first domain of a plurality of domains comprising the time domain, the frequency domain, and the spatial domain, and the adaptation of the one or more resources is associated with one or more second domains of the plurality of domains based at least in part on the change in configuration or the change in scheduling being associated with the first domain of the plurality of domains.

Aspect 38: The method of aspect 37, wherein the first domain and at least a one of the one or more second domains are a same domain.

Aspect 39: The method of any of aspects 37 through 38, wherein the first domain and the one or more second domains are different domains.

Aspect 40: The method of any of aspects 28 through 39, further comprising: transmitting a request message that requests the UE to report the adaptation of the one or more resources, wherein receiving the request message is based at least in part on receiving the second control message; and receiving a response message indicative of the adaptation of the one or more resources, wherein adapting the one or more resources is based at least in part on transmitting the response message.

Aspect 41: The method of aspect 40, wherein the request message requests the UE to report the adaptation of the one or more resources in at least one of the time domain, the frequency domain, and the spatial domain.

Aspect 42: The method of any of aspects 40 through 41, wherein the request message is indicative of a candidate adaptation of the one or more resources, and the response message is indicative of whether the UE is able to support the candidate adaptation.

Aspect 43: The method of any of aspects 28 through 42, further comprising: receiving a third control message indicative of a plurality of a candidate adaptations of the one or more resources in the time domain, the frequency domain, the spatial domain, or any combination thereof, and usage costs that are individually associated with each candidate adaptation of the plurality of candidate adaptations, wherein the change in configuration of the UE or the change in scheduling of the UE is based at least in part on the usage costs.

Aspect 44: The method of aspect 43, wherein the usage costs are per CC.

Aspect 45: The method of any of aspects 43 through 44, wherein the third control message is indicative of a threshold processing power supported by the UE, and the change in configuration or the change in scheduling is based at least in part on the threshold processing power supported by the UE.

Aspect 46: The method of any of aspects 28 through 45, further comprising: transmitting a third control message indicative of a first mode of the UE of a plurality of modes supported by the UE, wherein the plurality of modes comprises the first mode that indicates that the UE is to adapt the one or more resources based at least in part on the change in configuration or the change in scheduling and a second mode that indicates that the UE is to refrain from adaptation of the one or more resources.

Aspect 47: The method of any of aspects 28 through 46, further comprising: transmitting a third control message that indicates that the UE is to adapt the one or more resources based at least in part on the change in configuration or the change in scheduling.

Aspect 48: The method of any of aspects 28 through 47, further comprising: transmitting a third control message indicative of the adaptation of the one or more resources in the time domain, the frequency domain, the spatial domain, or any combination thereof, wherein adaptation of the one or more resources is based at least in part on receiving the third control message.

Aspect 49: The method of aspect 48, further comprising: receiving a request message indicative of a candidate adaptation of the one or more resources in the time domain, the frequency domain, the spatial domain, or any combination thereof, wherein receiving the third control message is based at least in part on transmitting the request message, and wherein the adaptation of the one or more resources is based at least in part on the candidate adaptation of the one or more resources requested by the UE.

Aspect 50: The method of any of aspects 28 through 49, further comprising: transmitting a third control message indicative of a plurality of relationships between a plurality of changes in configuration of the UE, a plurality of changes in scheduling of the UE, or both, and a plurality of adaptations of the one or more resources in the time domain, the frequency domain, the spatial domain, or any combination thereof, wherein adaptation of the one or more resources is based at least in part on the plurality of relationships.

Aspect 51: The method of any of aspects 28 through 50, wherein the first control message further indicates one or more threshold durations associated with performing resource adaptation, and adaptation of the one or more resources is based at least in part on the one or more threshold durations.

Aspect 52: The method of aspect 51, wherein the one or more threshold durations are based at least in part on the change in configuration or the change in scheduling.

Aspect 53: The method of any of aspects 28 through 52, wherein the change in configuration or the change in scheduling is associated with a SCell activation, a SCell deactivation, a cell dormancy, a change in DRX mode configuration, a BWP switch, a change in scheduling gap, a change in a threshold quantity of MIMO layers, a change in MCS, or any combination thereof.

Aspect 54: The method of any of aspects 28 through 53, wherein the change in configuration of the UE or the change in scheduling of the UE is associated with the time domain, the frequency domain, the spatial domain, or any combination thereof.

Aspect 55: A UE for wireless communications, comprising one or more memories storing processor-executable code, and one or more processors coupled with the one or more memories and individually or collectively operable to execute the code to cause the UE to perform a method of any of aspects 1 through 27.

Aspect 56: A UE for wireless communications, comprising at least one means for performing a method of any of aspects 1 through 27.

Aspect 57: A non-transitory computer-readable medium storing code for wireless communications, the code comprising instructions executable by one or more processors to perform a method of any of aspects 1 through 27.

Aspect 58: A network entity for wireless communications, comprising one or more memories storing processor-executable code, and one or more processors coupled with the one or more memories and individually or collectively operable to execute the code to cause the network entity to perform a method of any of aspects 28 through 54.

Aspect 59: A network entity for wireless communications, comprising at least one means for performing a method of any of aspects 28 through 54.

Aspect 60: A non-transitory computer-readable medium storing code for wireless communications, the code comprising instructions executable by one or more processors to perform a method of any of aspects 28 through 54.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a first control message indicative of a capability of the UE to support re-use of UE resources across different dimensions, wherein the first control message is configured to report capabilities of the UE to support re-use of UE resources in a time domain, a frequency domain, a spatial domain, or any combination thereof;
receive a second control message indicative of a change in configuration of the UE or a change in scheduling of the UE; and
adapt one or more resources in the time domain, the frequency domain, the spatial domain, or any combination thereof, in accordance with the change in configuration or the change in scheduling based at least in part on the capability of the UE to support re-use of UE resources across different dimensions.

2. The UE of claim 1, wherein the one or more processors are individually or collectively further operable to execute the code to cause the UE to:
receive one or more third control messages indicative of one or more time intervals, one or more duty cycles, or both, associated with the change in configuration or the change in scheduling, wherein adaptation of the one or more resources is based at least in part on the one or more time intervals, the one or more duty cycles, or both.

3. The UE of claim 2, wherein the one or more processors are individually or collectively further operable to execute the code to cause the UE to:
transmit a request message that requests the one or more time intervals, the one or more duty cycles, or both, associated with the change in configuration or the change in scheduling, wherein receiving the one or more third control messages is based at least in part on transmitting the request message.

4. The UE of claim 2, wherein the one or more time intervals, the one or more duty cycles, or both, are indicated per domain associated with the change in configuration of the UE or the change in scheduling of the UE.

5. The UE of claim 1, wherein the capability of the UE to support re-use of UE resources across different dimensions is reported per domain, per band combination, per band per band combination, per feature set per component carrier, or any combination thereof.

6. The UE of claim 1, wherein the change in configuration or the change in scheduling is associated with a first component carrier of a plurality of component carriers supported by the UE, and wherein the adaptation of the one or more resources is associated with one or more second component carrier of the plurality of component carriers based at least in part on the change in configuration or the change in scheduling being associated with the first component carrier of the plurality of component carriers.

7. The UE of claim 1, wherein the change in configuration or the change in scheduling is associated with a first domain of a plurality of domains comprising the time domain, the frequency domain, and the spatial domain, and wherein the adaptation of the one or more resources is associated with one or more second domains of the plurality of domains based at least in part on the change in configuration or the change in scheduling being associated with the first domain of the plurality of domains.

8. The UE of claim 1, wherein the one or more processors are individually or collectively further operable to execute the code to cause the UE to:
receive a request message that requests the UE to report the adaptation of the one or more resources, wherein receiving the request message is based at least in part on receiving the second control message; and
transmit a response message indicative of the adaptation of the one or more resources, wherein adapting the one or more resources is based at least in part on transmitting the response message.

9. The UE of claim 8, wherein the request message requests the UE to report the adaptation of the one or more resources in at least one of the time domain, the frequency domain, and the spatial domain.

10. The UE of claim 8, wherein the request message is indicative of a candidate adaptation of the one or more resources, and wherein the response message is indicative of whether the UE is able to support the candidate adaptation.

11. The UE of claim 1, wherein the one or more processors are individually or collectively further operable to execute the code to cause the UE to:
transmit a third control message indicative of a plurality of candidate adaptations of the one or more resources in the time domain, the frequency domain, the spatial domain, or any combination thereof, and usage costs that are individually associated with each candidate adaptation of the plurality of candidate adaptations, wherein the change in configuration of the UE or the change in scheduling of the UE is based at least in part on the usage costs.

12. The UE of claim 1, wherein the one or more processors are individually or collectively further operable to execute the code to cause the UE to:
receive a third control message indicative of a first mode of the UE of a plurality of modes supported by the UE, wherein the plurality of modes comprises the first mode that indicates that the UE is to adapt the one or more resources based at least in part on the change in configuration or the change in scheduling and a second mode that indicates that the UE is to refrain from adaptation of the one or more resources.

13. The UE of claim 1, wherein the one or more processors are individually or collectively further operable to execute the code to cause the UE to:
receive a third control message that indicates that the UE is to adapt the one or more resources based at least in part on the change in configuration or the change in scheduling.

14. The UE of claim 1, wherein the one or more processors are individually or collectively further operable to execute the code to cause the UE to:
receive a third control message indicative of the adaptation of the one or more resources in the time domain, the frequency domain, the spatial domain, or any combination thereof, wherein adaptation of the one or more resources is based at least in part on receiving the third control message.

15. The UE of claim 14, wherein the one or more processors are individually or collectively further operable to execute the code to cause the UE to:
transmit a request message indicative of a candidate adaptation of the one or more resources in the time domain, the frequency domain, the spatial domain, or any combination thereof, wherein receiving the third control message is based at least in part on transmitting the request message, and wherein the adaptation of the one or more resources is based at least in part on the candidate adaptation of the one or more resources requested by the UE.

16. The UE of claim 1, wherein the one or more processors are individually or collectively further operable to execute the code to cause the UE to:
receive a third control message indicative of a plurality of relationships between a plurality of changes in configuration of the UE, a plurality of changes in scheduling of the UE, or both, and a plurality of adaptations of the one or more resources in the time domain, the frequency domain, the spatial domain, or any combination thereof, wherein adaptation of the one or more resources is based at least in part on the plurality of relationships.

17. The UE of claim 1, wherein the first control message further indicates one or more threshold durations associated with performing resource adaptation, and wherein adaptation of the one or more resources is based at least in part on the one or more threshold durations.

18. The UE of claim 17, wherein the one or more threshold durations are based at least in part on the change in configuration or the change in scheduling.

19. A method for wireless communications at a user equipment (UE), comprising:
transmitting a first control message indicative of a capability of the UE to support re-use of UE resources across different dimensions, wherein the first control message is configured to report capabilities of the UE to support re-use of UE resources in a time domain, a frequency domain, a spatial domain, or any combination thereof;
receiving a second control message indicative of a change in configuration of the UE or a change in scheduling of the UE; and
adapting one or more resources in the time domain, the frequency domain, the spatial domain, or any combination thereof, in accordance with the change in configuration or the change in scheduling based at least in part on the capability of the UE to support re-use of UE resources across different dimensions.

20. A user equipment (UE) for wireless communications, comprising:
means for transmitting a first control message indicative of a capability of the UE to support re-use of UE resources across different dimensions, wherein the first control message is configured to report capabilities of the UE to support re-use of UE resources in a time domain, a frequency domain, a spatial domain, or any combination thereof;
means for receiving a second control message indicative of a change in configuration of the UE or a change in scheduling of the UE; and
means for adapting one or more resources in the time domain, the frequency domain, the spatial domain, or any combination thereof, in accordance with the change in configuration or the change in scheduling based at least in part on the capability of the UE to support re-use of UE resources across different dimensions.
